(19) United States
(12) Patent Application Publication
(10) Pub. No.: US 2008/0289526 A1
(43) Pub. Date: Nov. 27, 2008

(54) Method for imparting three-dimensional images and indicia to planar coated surfaces

(76) Inventor: Bruce Kenneth Bachman, Bonita, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/075,009

(22) Filed: Mar. 6, 2008

Related U.S. Application Data
(60) Provisional application No. 60/905,346, filed on Mar. 6, 2007.
(60) Provisional application No. 60/905,383, filed on Mar. 6, 2007.

(51) Int. Cl. B41F 1/18

(52) U.S. Cl. 101/450.1

(57) ABSTRACT

A method for imparting indicia to a wet-film of resinous liquid and magnetically positionable particles located on a substrate. The device employs a planar magnet abutting a planar metal sheet imaging indicia formed thereon. The planar metal sheet interacts with the magnetic field communicated to the wet-film to form indicia into the wet-film through migration and reorientation of the particles along the lines of the field. The letters, numbers, logos, or other images formed as indicia may be formed such that when viewed they appear three dimensional.

This application claims priority from U.S. Provisional Patent Application Ser. No. 60/905,346 filed Mar. 6, 2007, and U.S. Provisional Patent Application Ser. No. 60/905,383 filed Mar. 6, 2007, both of which are incorporated herein in their entirety by reference. The disclosed invention relates to paint or coatings used for spay painting, silk screening, or other processes where a paint is adhered to a surface of substrate. More particularly it relates to a formulation for such a paint or coating used in such processes, which imparts the coating to the articles and surfaces and which upon drying, appears to a viewing person to have three dimensional-like images. Employing specific formulations to the paint having magnetic pigment compositions, the improvement overcomes conventional limitations of both lack of detail and clarity as well as concurrently enabling an increase in the rate of production of such images applied to article or surfaces or substrates.

### FIELD OF THE INVENTION

### Background of the Invention

Enclosures, housings, covers, planar surfaces or even stand-alone single pieces from a set are frequently coated with paint for protective purposes and especially for decorative purposes. Paint as employed herein, means any liquid, liquefiable, or mastic composition, which after application to a substrate or surface in a thin layer, cures or dries to an opaque substantially solid film.

In modern society, products such as enclosures, housings, covers, planar surfaces and products are frequently designed and manufactured from ferrous or non-ferrous materials such as aluminum, magnesium, copper, brass, zinc castings, or of injection molded plastics or magnesium; graphite composites or epoxies, thermoformed plastic sheeting, molded urethanes or RIM molded urethanes, in-molded decorated films or polymer sheets and a plethora of other types of materials. It is an important step for both marketing and product manufacturing of such products that exterior surfaces are often filmed or coated for either functional or cosmetic and decorative purposes.

For decorative purposes, coatings having magnetically oriented pigments have in recent times been employed in paint and coatings for some products to render indicia and cured three-dimensional figures to the product surfaces using magnetic fields to arrange and align the magnetically influenced pigments into an image, letter, logo, pattern, symbol or other design type of indicia.

The current methods for achieving these induction influenced images generally comprises applying a layer of paint having a carrier and magnetically influenced pigments in liquid form onto upon a surface or substrate. Such conventional paint or film usually contains magnetically influenced particles or flakes which will react and reorient in proximity to a magnetic field. Once the liquid coating is applied by spraying, silkscreening, or other conventional means of application to the surface, a magnetic field is imparted onto selected regions of the applied paint or film while the coating is in a wet-film state. The field alters and imparts an orientation to the magnetically influenced particles or flakes in the wet-film. Once so oriented, the coating cures or dries to a solid film state thereby fixing the reoriented particles or flakes into angled and other non-parallel orientations upon the substrate being coated thereby rendering an image having a spatial effect upon the substrate it covers.

It is important in the current mode of such coating, to leave the wet-film coating adjacent to the source of the magnetic field, for a duration long enough for the wet-film coating co-solvents to sufficiently flash off to render the wet-film to a state that maintains the particles in their orientations for the image or indicia to be properly rendered to the surface. If the wet-film of applied paint is too liquid, the wet-film can flow, or the magnetically positionable particles may move, both of which distort the image, even though the image itself is fixed.

It is imperative that tooling imparting the image or indicia provides a field of induction that reorients the magnetically orientable particles to clearly form the image and that the wet film coating dry sufficiently to maintain those magnetically influenced particles in their achieved orientations. Without a clear communication of the magnetic field or sufficient drying time during such communication, the image or indicia rendered in the film layer upon the substrate surface by the field will disperse, diffuse, or may entirely disappear if the substrate having the formed images is moved too soon and before sufficient drying time for the wet film has elapsed.

However, conventional tooling and methods for producing the magnetic field to induce movement of the magnetically influenced particles place the magnetic source and induced field below or underneath the substrate or product surface being coated. Such positioning impairs production as the piece-part or product surface being coated or painted. This is because the part must be moved above the magnetic source and engaged upon a jig or mounted above the field-producing magnet and held in that exact position until the wet-film paint layer dries.

Coating or painting of the piece-part of substrate surface while upon a jig or mounting positioned above the field producing magnet directly is replete with problems. Because the substrate or product surface being imaged is placed in a spaced position only above the magnet, orientation of the particles for focus or sharpness of the produced image is limited to the magnetic field from below the substrate at the fixed length between the magnet and the substrate. Consequently, no means for adjustment of the imparted image through a depth of field alteration of the orientation of the magnetic particles is provided.

Additionally, conventional methods of application of the coating material generally employ spraying of the coating upon the substrate surface while the component is positioned above the magnetic source. Other types of application of the coating layer would be employable if the magnetic source were moveable as well as the piece-part or product surface to be imaged.

Still further, because of the configuration of conventional magnets and tooling for imparting images to coatings, most such images are limited to very small areas, and if placed on larger areas, the image produced in the paint layer on the substrate suffers from excessive lines of induction and distortions in the background of the image so formed.

Accordingly, there is an unmet need for a magnetic imaging tool which will allow large images or small images on large substrate surfaces to be formed and concurrently which also does not distort adjacent or background surfaces surrounding the image. Such a device should provide for communication of the magnetic field to the substrate surface being imaged, in a method from either above or below the substrate surface. Such a device should allow for a vertical positioning adjustment above or below the surface to be imaged in a method to thereby focus the induced image so produced, by adjusting the distance from it to thereby providing a means for adjusting depth of field of the produced image. Still further, such a device should allow for mass or high-volume production by allowing movement of many piece-parts or substrate or product surfaces to be imaged, incorporating the magnetic imaging tooling for communication of a induced magnetic field for a sufficient time period to form an image upon the targeted piece-parts or product surface.

In this respect, before explaining at least one embodiment of the invention in detail, it is to be understood that the invention is not limited in its application to the details of construction and to the arrangement of the components set forth in the following description or illustrated in the drawings nor the steps outlined in the specification. The invention is capable of other embodiments and of being practiced and carried out in various ways as those skilled in the art will readily ascertain from reading this application. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods and systems for carrying out the several purposes of the present invention of a device and method for imparting magnetically induced images to a layer of paint or coating upon a substrate. It is important, therefore, that the claims be regarded as including such equivalent construction insofar as they do not depart from the spirit and scope of the present invention.

It is thus an object of the invention to provide a magnetic imaging tool which will impart a clear and focused image or multiple images to a substrate surface having a layer of paint or wet-surface coating containing magnetically orientable or reorienting particles upon it, and which employs planar magnets and a planar interface to prevent distortion of the background surrounding the indicia being imparted into the wet-film.

It is a further object of this invention to provide such a device which is adjustable along a vertical axis to variable distances above or below the substrate or piece-part surface being imaged, to provide a method for achieving a depth of field adjustment to the formed image to adjust sharpness and focus of foreground and background indicia.

It is a further object of this invention to provide such a magnetic imaging tool which in a method of use will produce especially clean, sharp and defined images through the provision and employment of an interface induction plate and jigging, and calculated spacing and/or thickness of the magnetic field source in relation to image forming apertures formed into the induction plate.

Yet another object of this invention is the provision of a method of forming such a magnetic imaging device and employing it to form indicia in wet-film layers of paint having magnetically positionable particles therein.

These together with other objects and advantages which will become subsequently apparent reside in the details of the magnetic imaging tooling and methods of use and formation as more fully hereinafter described herein with reference being had to the accompanying drawings forming a part thereof.

### BRIEF DESCRIPTION OF DRAWINGS

FIG. 1 is a simplified cross-sectional view of the device in a simple form for communication of electrical charged forces of induction from anisotropic and axial pole magnet sheets (of various kinds) and supporting jig having a component providing the substrate with a wet-film material thereon such that the magnetic filed communicates through the wet film and substrate and orients particles within the wet-film to form an image therein.

FIG. 2 is a simplified cross section depicting a section of a component forming a substrate with a layer of substantially transparent wet-film paint containing magnetically orientable particles formed of iron, nickel or other particles therein and optional top coat film.

FIG. 3 is a simplified cross section of substrate with clear or transparent colored resin film containing additive of iron or other magnetically orientable or granular spheres, particles or flakes with a specialty additive to maintain the orientation of the particles.

FIG. 4 is a simplified cross section of a substrate with substantially transparent resin film containing magnetically orientable particles in granular spheres or flakes or other shapes, are subjected to electrical charged forces of induction (magnetic) and depicting movement of electrical charged forces of induction from anisotropic and axial pole sheets of various kinds which are engaged to the tool positioned on the same side of the substrate as the film.

FIG. 5 is a simplified cross section of a substrate with a layer of resin film containing magnetically orientable particles of granular spheres, particles or flakes and depicting electrical charged forces or lines of induction (magnetic) causing migration and reorientation of the positionable particles within the wet film from the underside of the substrate.

FIG. 6 is a simplified cross section of a substrate with a layer of resin film containing magnetically orientable particles and incorporating an induction imaging tool and movement of electrical charged forces of induction from anisotropic and axial pole sheet magnets.

FIG. 7 is a top plan view of indicia in the form of a “Splash” design image outline typical of which may be produced with the device and method herein.

FIG. 8 is a top plan view of indicia in the form of a “PWBA”—printed wiring circuit board typical of which may be produced with the device and method herein.

FIG. 9 is a top plan view of indicia on a substrate formed by an LCD DVD rear screen cover piece-part component with a “Circles” pattern image outline typical of which may be produced with the device and method herein.

FIG. 10 is a top plan view of indicia on a substrate formed by an LCD DVD rear screen cover piece-part component with a “Squares” pattern image outline typical of which may be produced with the device and method herein.

FIG. 11 is a top plan view of indicia on a substrate formed by an LCD DVD rear cover piece-part component with “Seascape” design image outline typical of which may be produced with the device and method herein.

FIG. 12 is a top plan view of indicia formed on a substrate of an LCD DVD front cover piece-part component showing a “Circles” pattern image imparted by the induction tool design superimposed or overlaid typical of which may be produced with the device and method herein.

FIG. 13 is a top plan view of indicia formed on a substrate of an LCD DVD front cover piece-part component with “Square” pattern image of induction tool design superimposed or overlaid typical of which may be produced with the device and method herein.

FIG. 14 is a top plan view of indicia formed on a substrate of an LCD DVD front cover piece-part component with a “Seascape” design image of induction tool design superimposed or overlaid, typical of which may be produced with the device and method herein.

FIG. 15 is a top plan view of indicia formed on a substrate depicting a typical “Logo” indicia design image outline typical of which may be produced with the device and method herein.

FIG. 16 is a top view of the “Logo” of FIG. 15 showing the addition of lettering denoting a brand name in parallel typical of which may be produced with the device and method herein.

FIG. 17 is a top view of the “Logo” of FIG. 15 showing the addition of lettering denoting a brand name in series, typical of which may be produced with the device and method herein.

FIG. 18 is a simplified cross section of piece-part forming the substrate with the resin film containing the magnetically orientable particles within the wet film showing the induction imaging tool device herein communicating charged forces of induction from anisotropic and axial pole sheets on underside side of substrate, and depicting the induction imaging tool and/or anisotropic and axial pole sheets being dimensionally larger than piece-part forming the substrate in both X and Y axis.

FIG. 19 is a simplified cross section of the piece-part forming a substrate with the resin film containing the magnetically orientable particles within the wet film depicting the induction imaging tool device depicting communication of electrical charged forces of induction from anisotropic and axial pole sheets of various kinds on the upper or top side of substrate showing the induction imaging tool and/or anisotropic and axial pole sheets being dimensionally larger than substrate, in both X and Y axis.

FIG. 20 is an exploded perspective view showing substrate with the resin film containing the magnetically orientable particles within the wet film showing incorporation of the induction imaging tooling and resulting communication of electrical charged forces of induction from anisotropic and axial pole sheets of various kinds positioned on the same side of substrate as the wet-film and showing the induction imaging tooling and/or pole sheets being dimensionally larger than the substrate in both X and Y axis and showing part jig and jig supporting base plate.

FIG. 21 is a perspective view of an off-line, work stand base with manual articulating lid, with supporting part jig base plate, part jig, and the piece-part or component providing a substrate and with the resin film containing the magnetically orientable particles within the wet film, depicting a mode of the imaging tool device herein and communication of electrical charged forces of induction from anisotropic and axial pole sheets of various kinds, showing the tooling and/or pole sheets being dimensionally larger than the substrate in both X and Y axis, and having an articulating lid to register induction imaging tooling and pole sheets in precise alignment, and a controlled proximity to the wet film coated substrate.

FIG. 22 is a perspective view of off-line, work stand base with a mechanically operated articulating lid, with the supporting piece-part jig base plate, piece-part jig and a piece-part providing a substrate having a layer of resin film containing the magnetically orientable particles within the wet film and depicting the induction imaging tool communicating electrical charged forces of induction from anisotropic and axial pole sheets, with the tooling and/or pole sheets being dimensionally larger than the substrate in both X and Y axis, secured to a work stand where the articulating lid will register imaging tooling and pole sheets in precise alignment and controlled proximity to wet film coated substrate.

FIG. 23 is a perspective view of an in-line shuttle or ball screw positioning table type work stand base with a mechanically operated articulating lid and supporting piece-part jig base plate, piece-part jig, and a piece-part providing a substrate having a layer of resin film containing the magnetically orientable particles within the wet film and showing the induction imaging tool communicating electrical charged forces of induction from anisotropic and axial pole sheets of various kinds and the tooling and/or pole sheets being dimensionally larger than the substrate in both X and Y axis. Operation of the articulating lid registers the imaging tooling and pole sheets in precise alignment and controlled proximity to the coated substrate for an automated, inline or lights-out operation with camera QC/QA.

FIG. 24 is a perspective view of communication of electrical charged force of induction from anisotropic and axial with a single pole per face magnet.

FIG. 25 is a perspective view of communication of electrical charged force of induction from anisotropic and axial with a two poles per face magnet.

FIG. 26 is a perspective view of movement of electrical charged force of induction from anisotropic and axial with a three poles per face magnet.

FIG. 27 is a perspective view of movement of electrical charged force of induction from anisotropic and axial with a three poles per face, opposite axis magnet.

FIG. 28 is a perspective view of movement of electrical charged force of induction from anisotropic and axial with a four poles edge-centered per face magnet.

FIG. 29 is a perspective view of movement of electrical charged force of induction from anisotropic and axial with a four poles corner-centered per face magnet.

FIG. 30 is a perspective view of movement of electrical charged force of induction from a multiple-poles per face magnet.

FIG. 31 is a perspective view of the indicia imaging tool as would be employed to orient the magnetically orientable particles in the wet-film for Letter “I”.

FIG. 32 is a perspective view of the indicia imaging tool as would be employed to orient the magnetically oriented particles in the wet-film to form a “Splash” design.

FIG. 33 is a perspective view of the indicia imaging tool as would be employed to orient the magnetically oriented particles in the wet-film to form the Letter “I” in a reverse or concave effect.

FIG. 34 is a perspective view of the indicia imaging tool as would be employed to orient the magnetically oriented particles in the wet-film to depict the “Splash” in a reverse or concave effect when viewed.

FIG. 35 is a top perspective view of an exemplar “Auvi” design logo and letter name as formed in the wet-film covering a substrate by the method and apparatus herein with the background substantially undisturbed in a first design option.

FIG. 36 is a top perspective view of the “Auvi” design logo of FIG. 35 in a second design option by the method and apparatus herein wherein the particles only in the background are oriented to form the design.

FIG. 37 is a top perspective view of the “Auvi” design logo of FIG. 35 in a third design option producible by the method and apparatus herein wherein the particles of the letters and logo are oriented in on manner and the particles of the background oriented in another manner to form the design.

FIG. 38 depicts a top perspective view of the “Durabrand” Logo and letter name produced in the first design option or particle orientation as in FIG. 35.

FIG. 39 depicts a top perspective view of the “Durabrand” Logo and letter name as in the second design option of particle orientation as in FIG. 36.

FIG. 40 depicts a top perspective view of the “Durabrand” Logo and letter name as in the third design option of particle orientation as in FIG. 36.

FIG. 41 is a top perspective view of the “Auvi” design logo and letter name in the first design option cut metal tool to impart indicia.

FIG. 42 is a top down slight angled view of “Auvi” design logo and letter name in the second design option cut metal tool to impart indicia.

FIG. 43 is a top down slight angled view of “Auvi” design logo and letter name in the third design option cut metal tool to impart indicia.

FIG. 44 is a cross sectional view of the disclosed metal imaging tool to impart indicia by orienting the particles suspended in the wet-film design with varying dimensions of the formed paths in the planar tool to orient the particles in the wet-film to vary the degree or level of the viewed indicia on the substrate while maintaining overall indicia dimensions.

FIG. 45 is a top plan view of the “Durabrand” Logo and letter name indicia as may be formed by particle orientation in the wet-film covering a substrate by the method and apparatus herein where the substrate is a DVD LCD rear piece-part component housing.

FIG. 46 is a top down view of “Durabrand” Logo and letter name indicia as formed in the wet-film covering a substrate by the method and apparatus herein viewed at an angle substantially perpendicular to the DVD LCD rear piece-part component.

FIG. 47 is a top down view of indicia of “Durabrand” Logo and letter name indicia of FIG. 45 viewed at a non-perpendicular angle to the surface of the rear piece-part component with outline of design imaging showing the achievable three-dimensional or spatial effect from orienting the particles at varying angles to the substrate.

FIG. 48 is a top down view of “Durabrand” Logo and letter name indicia on substrate such as an DVD LCD rear piece-part component with outline of invention or discovery proper induction image tool design or movement of electrical charged forces of induction from anisotropic and axial pole sheets of various kinds for indicia.

FIG. 49 is a simplified cross sectional view of work stand having a base support for a substrate of a piece or component of a manufactured item such as a laptop computer.

FIG. 50 is a top down view of example of DVD LCD rear piece-part providing the substrate to be held, secured, aligned and registered onto supporting work jig with tool indicia design superimposed.

FIG. 51 is a perspective exploded view of a work base, jig supporting base plate and piece-part or component substrate jig for securing, locating, registering and aligning features for orientation of the particles to achieve the indicia of FIG. 49. FIG. 50 DVD LCD rear piece-part component for indicia.

FIG. 52 is a top plan view of the “Splash” indicia design formed by orienting the particles in the wet-film layer on the substrate and with a laser etch outline.

### DETAILED DESCRIPTION OF DRAWINGS AND PREFERRED EMBODIMENTS

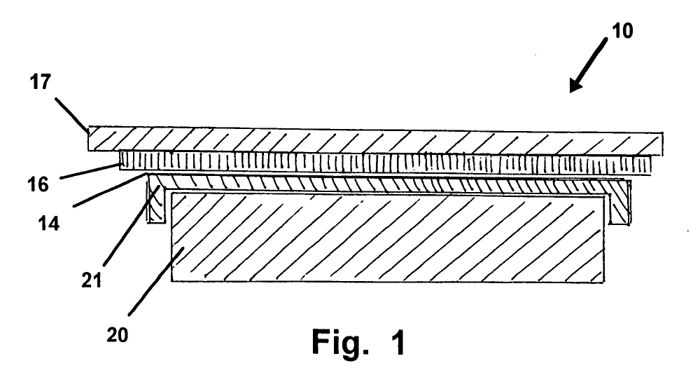

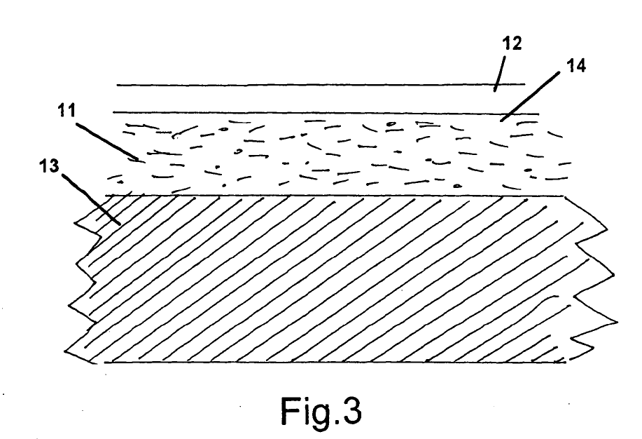

Referring now to the drawings in FIGS. 1-52, FIG. 1 depicts elements common to all modes of the device 10 in its various modes and embodiments when employed to orient and/or gather magnetically orientable particles 11 in wet-film 14 layers or coatings placed on a part or product component or other substrate 13. Such coating or paint material forming the wet-layer 14 is first applied to the substrate 13 and is generally comprised of substantially clear or transparent colored resin forming a wet-film layer 14. In the wet-film layer 14 are magnetically positionable particles 11 of iron, nickel or other magnetically orientable particles 11 in shaped as spheres, rods, chips, or other shapes and sizes which when oriented by the field lines in a magnetic field from the device herein, will re-group and reorient along those lines and provide the appearance of width, depth, and height, in the indicia formed on a planar substrate 13.

Employing magnetic fields communicated with the device 10 and employing the method herein, the particles 11 are angularly orientable in three dimensions within the wet-film layer 14. As can be discerned, elongated rod-like or flake-type particles, reorienting along field lines will reflect light to the eye of the user and provide the three-dimensional or spatial effect to the indicia 19 formed in the wet-film 14. Once the particles 11 are oriented by the field, the wet-film 14 is allowed to dry, thereby affixing the field-oriented positions and grouping of the particles 11 at positions and angles to render indicia 19 with three-dimensional and spatial effects to the person viewing it. Ideally the wet-film 14 in addition to the substantially clear resinous material and magnetically positionable particles, should have an additive as a means to maintain magnetically positionable particle 11 orientation until the wet-film 14 sufficiently dries subsequent to removal of the magnetic field from communicating through the substrate 13 to maintain the indicia 19.

Employing the method and device 10 herein in its various modes to impart the indicia 19 into the layer of wet-film 14 resinous material or paint having iron or nickel or other magnetically positionable particles 11, a magnetic field is communicated through the substrate 13 and wet-film 14 in a calculable manner that causes the migration and reorientation of the positionable particles 11 to form a three-dimensional appearing indicia of letters, images, numbers, or other indicia which can have shadows and lines from the oriented particles 11 which appear to have depth, width, and height an contour and other three dimensional characteristics ascertained by the eye of a viewer. The formed images may have concave effects or convex effects or mixed viewable effects, depending on the placement of the magnet 17 and planar steel sheet forming the imaging tool 16 above or below the wet-film 14 being imaged, and by adjustment of the type and polarity of the planar magnets 17 placed behind the planar steel or ferrous sheet forming the imaging tool 16.

Depicted in FIG. 1 is a cross-sectioned view of the major functional components of the disclosed device 10 enabling the method herein. Prior art in the production of three-dimensional images in a wet-film layer 14 on substrates 13 has been limited to small images and indicia on piece-parts or component substrate surfaces due to poor image qualities and limited design indicia because of paint particle migration caused by the inferior tooling and methods and processing employed.

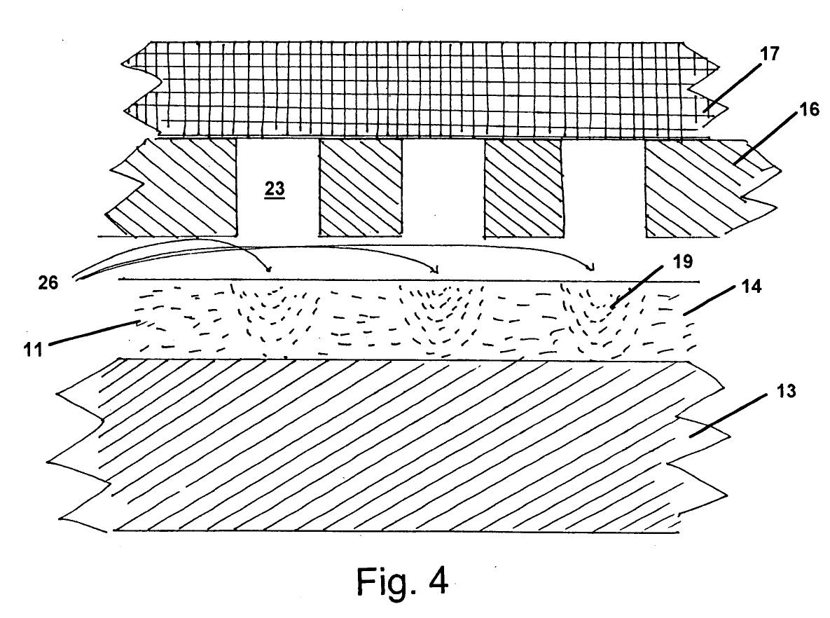

During experimentation on the device 10 and method herein it was discerned that the quality of imparted indicia 19 formed by migration and reorientation of the particles 11 along the flow and in direction of the field lines, (seen first in FIG. 4) through the wet-film 14, can be greatly improved through the employment of a magnet 17 or other means for inductive field generation, which is dimensionally larger in both length and width than the planar induction imaging tool 16 used to impart the image to the wet-film 11 containing the magnetically orientable particles 11. As shown in FIG. 1, the magnet 17 is larger than the planar imaging tool 16 which itself is larger than the area of the wet-film 14 to be imaged. Consequently it is a most preferred mode of the device 10 which incorporates this dimensioning scheme.

Also, in a most preferred mode of the device 10, the imaging tool 16 should also be dimensionally larger in both length and width, than the component 21 providing the substrate 13 for the wet-film 14 having the particles which migrate and orient along the magnetic field lines communicated through the wet-film 14 layer to form the indicia 19. This insures that the wet-film 14 surrounding the indicia 19 is not marred or corrupted by stray field lines but instead provides an even and clean background for the image or letters, or logo, or numbers, of the indicia 19. Further, employing the device and method herein, the depicted indicia may when viewed appear concave, convex, or in mixtures of three dimensional shapes, depending on the placement of the imaging tool 16 in a position above or below the wet-film 14 and the substrate 13 and depending on the polarity of surface of the planar magnet 17 behind the planar imaging tool 16.

The ability to hold the component 21 and its substrate 13 on a jig and move the tool 16 with engaged magnet 17 above or below the wet-film 14 provides this means to adjust the appearance of the produced image to achieve concave, convex, and other three-dimensional appearances to the viewer. Further, by providing magnets 17 with differing areas of total dimension with different pole configurations, indicia may have both convex and concave and other three dimensional characteristics in the same image.

By forming the area of the planar magnet 17 larger than the area of the planar imaging tool 16, it has been found that a means for an even dispersal of the magnetic field throughout the entire substrate 13 and wet-film 14 is provided outside the indicia 19 area. This produces a method of rendering the indicia 19 or image which is much more clearly imparted to the wet-film 14 on the substrate 13 such as a computer laptop or game cartridge, and has the additional benefit of providing a means to eliminate stray lines, ghosting, or other image defects and limitations which currently occur in conventional magnetic imaging and cause unwanted lines, gaps, and other imperfections and images in the background area of the wet-film surrounding the image formed by the indicia.

An additional discovery found during experimentation is the relationship of thickness of the steel plate forming the imaging tool 16 to image quality and definition. It was found that using a thinner plate to form the imaging tool 16 produced a less defined image and a thicker plate produced a more defined image. In both cases, however, the magnet 17 abutting the imaging tool 16 must have a perimeter larger than that of the imaging tool 16. Consequently, adjusting the thickness of the imaging tool 16 plate has been found to provide a means to proportionally change the resulting image definition in the coating formed of the dried wet-film 14.

Additionally, it has been found that using this arrangement of a larger planar magnet 17 adjacent to the steel plate forming the planar imaging tool 16, and engaging it to a translating mount along a vertical axis normal to the plane of the surface being painted, this translation toward and away from the substrate 13 provides a means for adjustment of the depth of field of the produced indicia 19 forming the image or images on the surface of the component 21 being painted. By placing the imaging tool 16 and magnet 17 closer to the paint or wet-film 14 layer or further from it, the resulting images and image edge definitions may be sharpened or diffused for a softer look.

Another aspect affecting image quality and image edge definition and improved herein is provided by the relationship of the thickness of the steel plate forming the imaging tool 16. As noted elsewhere in this application, apertures 23 in the imaging tool 16 communicating between both side planar surfaces of the tool 16 with both the top and bottom planar surfaces, help form the resulting image or indicia 19 on the substrate 13 being imaged. It has been found that the best resulting image quality is provided if the depth of the steel plate forming the imaging tool 16 is a least one-half the distance of the largest aperture measurement communicating through the steel plate of the imaging tool 16. For example, a 2 inch largest aperture measurement would require a thickness for the imaging tool 6 plate of at least 1 inch. Adjusting the depth or thickness of the steel plate forming the imaging tool 16 to this ratio is an especially important element employable as a means to produce the cleanest and most defined images with proper magnetic field dispersion around them and in the background, to eliminate defects and provide a clean background.

Note that in reducing the depth of the tool in relation to the largest aperture measurement allows for lessening or governing of the overall image balance which may also be desired in the resulting image, and is controllable to all degrees from near zero to full balance.

As can be seen in FIG. 1a, there is a conventional paint or film or similar wet-film 14 layer which is employed on piece-part or component 21 providing the substrate 13 surfaces for magnetic imaging. Such as substrates formed of components 21 of products are made from molded plastics, extruded and cast films or sheets, fabricated or machined metals, glass or ceramics, paper sheet, paper packaging, fabrics or other flexible and non-flexible substrate materials. In the conventional wet-film 14 a clear or transparent or translucent or opaque colored resin film is formed from a of variety of various acrylics or other resins and is used as a resinous vehicle to carry pigments which colorize the wet-film. Frequently, an optional clear or translucent top coat 12 of conventional acrylic, conventional cross linked polyurethane, polyurethane-enamels or UV cures urethanes is employed. Such coatings are used widely and have no inductive image properties.

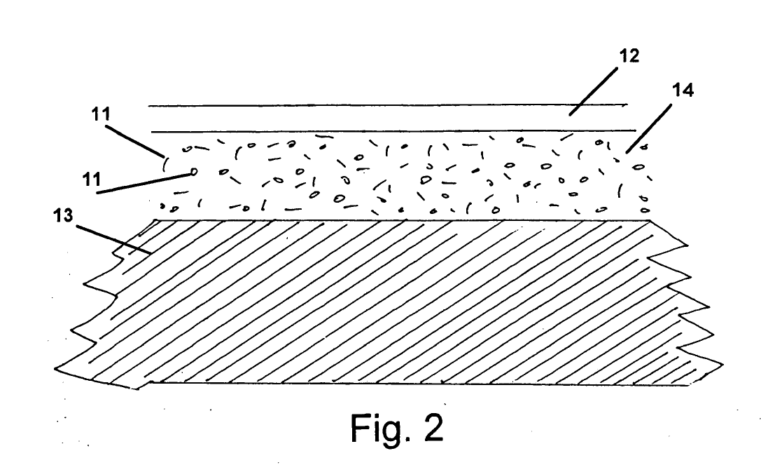

In FIG. 2, which is also conventional in the nature of prior and current art, the surface formed of various substrates 13 of molded plastics, extruded and cast films or sheets, fabricated or machined metals, glass or ceramics papers etc is covered by the clear or translucent or transparent colored resin wet-film 14 layer. Additive induction orientable particles 11 of iron, nickel or other oriented granular spheres, particles or flakes are included which orient along the electrical charged forces or lines of induction which communicate from a tool 16 through the wet-film 14 and substrate 13. This conventional coating is impaired by the inability to be moved too quickly from the magnetic source imparting the migration and redirection of the particles 11 to form the indicia 19 and an inability to coat vertical or side surfaces because of settling of the particles 11. However, employed with the magnets 17 and planar image tool 16 and vertical spacing of tooling and magnets from the wet-film 14 herein disclosed, this coating's abilities to produce clean images of a variety of designs such as lettering, patterns, logos etc. is also enhanced. This is because current methods of imparting images and indicia to such wet-film 14 employs simple magnets alone which are brought into proximity of the wet-film 14 to form a crude images.

The device and method herein work with conventionally employed paints and coatings which use a transparent resinous material with particles 11 which will reorient in a magnetic field. However, the formulation preferred would employ a resinous carrier including one or a combination of a polymer or epoxy or other material with sufficient transparency and clarity on drying not to impair the image or indicia formed by the particles 11. One such base resinous carrier material is a Sherman-Williams clear acrylic lacquer; however, those skilled in the art will realize that other substantially clear or transparent resinous carrier medium will suffice.

To that is added magnetically repositionable particles 11 preferably in the form of flakes formed entirely or partially of one or a combination of iron or nickel. Such particles are added by weight to equal from 0.5 to 20% of the total weight of the mixture of the formulation depending upon the desired density of the image. One such preferred particle is Eckart Ferricon 200 which is especially preferred for its flake formation. However, any flake, rod, or other shaped particle 11 which is orientable by the field lines of a magnetic field flux is acceptable and anticipated within the scope of this application. Such particles 11 are added by weight to equal from 0.5 to 20% of the total weight of the mixture of the resinous material and particle 11 formulation depending upon the density of the image desired in the wet-film.

Further, it has been found that the device 10 and method herein produced significantly enhanced images and production times using a formulation which includes an additive to maintain particle 11 orientation after removal of the imaging tool 16 and magnet 17. Through the employment of such an additive a means to maintain particle 11 migration and orientation along the lines of the magnetic field communicated through the wet-film 14 is provided so that the component 21 may be moved much more quickly and maintain the indicia 19 which is a major improvement allowing for volume production of magnetically imaged surfaces.

Means to maintain the orientation of the particles 11 positioned by the magnetic force in the wet-film 14, is currently best provided by the addition of a first additive in the form of a wax which when said wet-film 14 is dry, maintains a very clear or transparent nature so as not to impair the formed image. This final clarity in the dried paint is most important since the image formed by the oriented particles 11 would cloud or be impaired with an additive of improper clarity. The current preferred means for such stabilization or maintaining particle orientation in the wet-film 14 layer is best provided by inclusion of one or a combination of such wet-film stabilization additives including ethylene-vinyl-acetate copolymer (EVA) or ethylene acrylic acid (EAA) or ethylene with a mixture of xylene.

The wax content of the resinous carrier should equal approximately 20 to 60% with 50% resin solids by total weight being a particularly good ratio when employed with the device 10 and method herein.

Means to maintain particle 11 orientation after removal of the magnetic field from adjacent to the wet-film 14 layer having oriented particles 11 may be further enhanced by inclusion of an additive means to prevent settling of the particles 15 and sag if the wet-film 14 is on a vertically disposed substrate 13. This may be provided by inclusion of cellulose acetate butyrate (CAB) in combination with the first wax additive for this purpose noted above. The CAB offers increased protection against reorientation of the positioned particles 11 in the wet-film 14 and also against sag and settling of particles 11 repositioned by the magnetic 17 and imaging tool 16 on a vertically oriented substrate 13 which is sprayed or silkscreened or otherwise coated with the paint.

In situations where the wet-film 14 is on an inclined substrate 13, additional additives to protect against sag and settling of the paint and particles 11 in the vertically oriented substrate 13 being coated with paint by spaying silkscreening or other means for application, may also be added along with the first means to maintain particle orientation. One preferred such additional additive is hydrophilic silica with polyhydroxycarboxylic acid or organic modified clays with bentone. Or, modified urea with n-methyl-pyrollidone may be included.

Particularly preferred also in a production situation of high-volume imaging, is an additive means to maintain the applied wet-film 14 layer in a wet condition to allow reorientation of the magnetically positionable particles 11 before the wet-film 14 layer thickens too much or dries. Currently the preferred mode of this additive to maintain the wet-film 14 in a wet condition has been found to be diacetone alcohol (DEA) in a ratio of between 0.5 to 5% by weight with a particularly favored ratio between 2 to 3% of the total weight of the coating mixture. The ratio is adjusted upward as the size of the image imparted to the wet-film 14 increases to allow the larger area to maintain a uniform wetness. Currently between 2 to 3% is a favored ratio with 3% being used with larger indicia areas and 2% where smaller areas of uniform wetness is required.

Employing one or a combination of the additives noted herein noted will enhance the performance of the device 10 and method herein as shown in FIG. 4 where the substrate 13 being layered with the wet-film 14 is maintained in a wet-filmed state to allow migration and/or orientation of positionable particles 11 of iron or nickel or other magnetically positionable particles 11 along the lines of the charged force of induction or in the direction of the magnetic field lines or flux, when they are subjected to the magnetic field provided by the adjacent indicia imaging tool 16 which focuses or reorients the field from planar magnet 17.

It should be noted, that prior art indicia 19 imparting devices simply employ edge pole magnets to impart an inferior image in the wet-film 14. No employment of planar magnets 17 sized larger than the wet-film 14 surface or a steel interface imaging tool 16 is taught or suggested.

Most prior art magnets, such as sintered or bonded neodymium (NdFeB), rare-earth or ferrite magnets (Ba/Sr06 or Fe0), SMCO magnets (SmCo) or ALNICO magnets (Al—Ni—Fe—Co) have limitations. First and foremost is they are both very hard and extremely brittle. Second is they are very limited in size. Third is their fields are so powerful, they may be hazardous to handle against any magnetizable materials and, they impart unwanted lines and imperfections to the wet-film 14 outside the area of the indicia 19 and produce poor image quality in the indicia 19 itself.

Further, it is nearly impossible to drill, cut or fracture these magnets without catastrophic failures or possible injuries upon the user. Further, the largest of these conventionally employed magnets is perhaps 6″ by 6″ and their costs and weights are enormous. Finally, the fields produced by prior art magnets themselves can be so high that they are in-effect unsuitable and unusable for use to image a wet-film 14.

The planar magnets 17 employed herein may be custom formed to meet the noted length and width requirements to form the two sides of the planar magnet 17 larger than the substrate 13 or at least the wet-film 14 on the substrate to be imaged. In the method herein, if such a dimensional magnet is not available, it would be formed to meet these size requirements as a step.

The magnets 17 as noted are planar and may be flexible magnets such as those formed with strontium and/or barium ferrite powder and a polymer matrix which may be molded or extruded to the length, width, and thickness requirements for the device and method herein. One mode of the preferred magnets 17 are oriented through the thickness and are anisotropic axially north-south pole, opposite face magnets 17 with each face on the entire planar sheet being one of north or south entirely for the area of the side. Formed in this fashion, from the polymer and mixed magnetic material, the planar magnet 17 yields a uniform field with no disturbances or defects in the field lines. This substantially uniform field, interacting with the planar imaging tool 16 and the particles 11 in the wet-film 14 produces a defect-free indicia 19 and clean backgrounds and surrounding areas of the wet-film 14.

To achieve the required thickness in the method and apparatus, they may either be formed in that thickness, length and width to meet the noted requirements herein related to the indicia 19 and wet-film 14. Or, since each has a very even field, and one pole per side, they may be laid adjacent to each other to form larger planar magnets 17 to meet the requirement to exceed both the length and width of the wet-film 14 and preferably the substrate also. For interesting effects, the magnets 17 may also be formed with multiple poles per side thereby yielding even but alternating fields which will likewise yield concave and convex portions in the indicia 19.

The planar formed or extruded magnets 17 are preferred as noted for evenness of the generated field; however, other planar magnets may be employed from other materials or formations if they meet this general requirement and such is anticipated. However, currently a magnet formed from a flexible polymer mixed with magnetic materials noted and cured to a planar configuration is preferred due to the very even and predictable fields generated.

The communication of the charged force of induction from anisotropic and axial poles of the magnet 17 through the steel sheet forming the imaging tool 16 interface, and any apertures 23 or engraving or cavities formed therein, imparts indicia 19 by orientation to the particles 11 in the wet-film 14 along the lines of the field to and from the magnet 17. This action both migrates and reorients the particles 11 along the lines of the field thereby creating an image in the resin wet-film 14 in proximity to induction imaging tool 16. The formulation for the coating herein described and disclosed, may include one or a combination of the additives as a means to maintain the orientation of the particles 11 once the induction tooling is removed, and an additive means to maintain the resin employed as the carrier for the particles 11 sufficiently wet to allow the orientation of the particles 11 when subjected to the magnetic field. It is the formation of the magnet 17 in planar form and the employment of the interface in the form of steel planar imaging too 16 which makes the indicia 19 formed by the device and method herein far superior to that of any prior art.

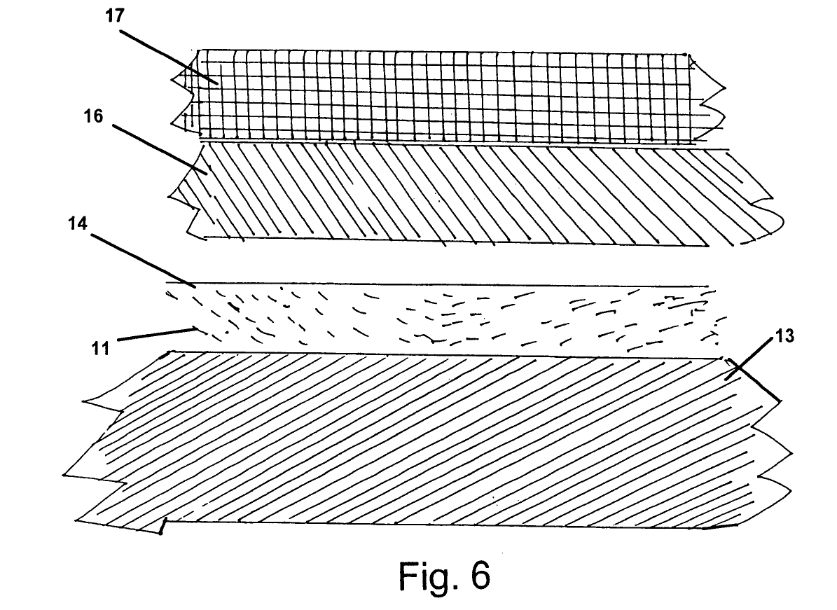

The use of conventional wet-film 14 formulas will still produce enhanced images from the configuration of the magnets 17 and planar imaging tool 16 from a position of the imaging tool 16 above or below the substrate 13; however, time must be allowed for the wet-film 14 to gel sufficiently to hold the image before removal. With the employment of the additives and formulation for the wet-film 14 noted herein, communication of the magnetic field from below the substrate surface 22 as shown in FIG. 4, or from above the substrate 13 as in FIG. 4 will yield much improved results in the image by allowing the substrate 13 coated with the wet-film 14 to be maintained in a wet filmed state to allow the migration or orientation of positionable particles 15 of iron or nickel or other magnetically positionable particles 11 to be removed before drying. Or, in an especially preferred mode, the magnetic field may be communicated from above the substrate surface 27 as shown in FIG. 6 since it may also be moved and the stabilized image maintained.

Means to maintain the orientation of the particles 11 positioned by the induced magnetic force may be added and currently is best provided by the addition of a first additive in the form of a wax which when dried maintains a very clear or transparent nature so as not to impair the formed image. This is most preferred for use with the device and method herein, since the image formed of indicia 19 from the migration and orientation of the particles 111 would cloud or be impaired with an additive of improper clarity. The current preferred means for such stabilization is best provided by inclusion of ethylene-vinyl-acetate copolymer (EVA) or ethylene acrylic acid (EAA) or ethylene with a mixture of xylene.

Also added singularly or in combination may be either or both of the above-noted additives to maintain wetness and to inhibit settling. One, two, or all three additives may be included singularly or in combinations depending on the user's preference; however, maintaining particle 11 orientation and wetness are especially preferred.

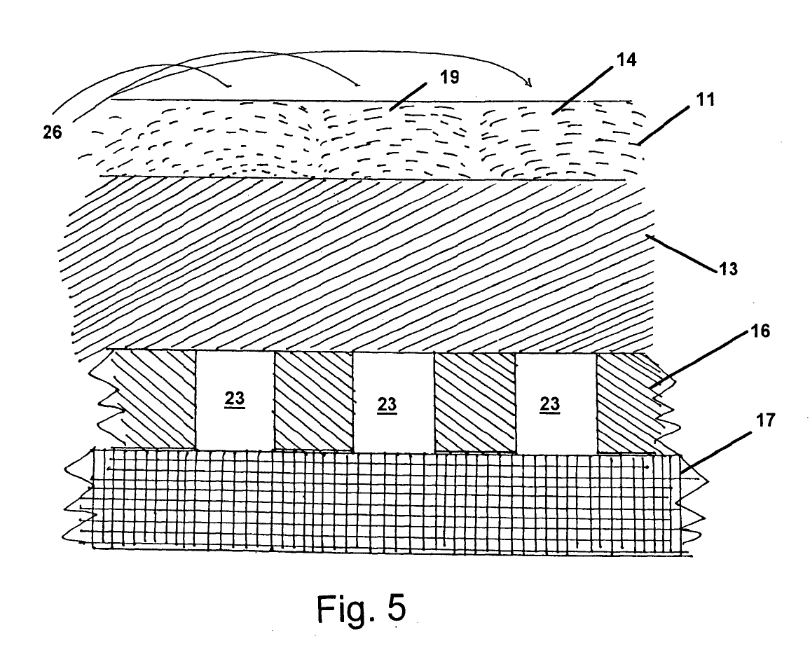

FIG. 5 shows the use of the described imaging tool 16 and planar magnet 17 having anisotropic and axial pole sheets of various kinds. The induction indicia imaging tool 16 is shown adjacent to the substrate 13 formed of any of the various substrates of molded plastics, extruded and cast films or sheets, fabricated or machined metal, glass or ceramics providing the surface or substrate 23 which can be imaged with the proper coating. The substrate 13 is shown being in a wet filmed state 23 to allows migration or reorientation of the particles 11 along the lines of the field 26 and as noted may be iron, nickel or other oriented granular spheres, particles or flakes which may be oriented by the charged forces of induction communicated from the magnet 17 through the imaging tool 16 through the wet-film 14. The particles 11 are shown migrating and reorienting along the lines of flux communicated through the wet-film 14 to thereby form the indicia 19 the planar imaging tool 16 imparts through focusing or directional flow imparted by the machining of the image into the imaging tool 16.

As noted earlier FIG. 6 shows a cross section of a substrate 13 with a layer of resin film forming the wet-film 14 and having magnetically orientable particles 11 and incorporating an induction imaging tool 16 and communication of electrical charged forces of induction from anisotropic and axial pole sheet magnets 17.

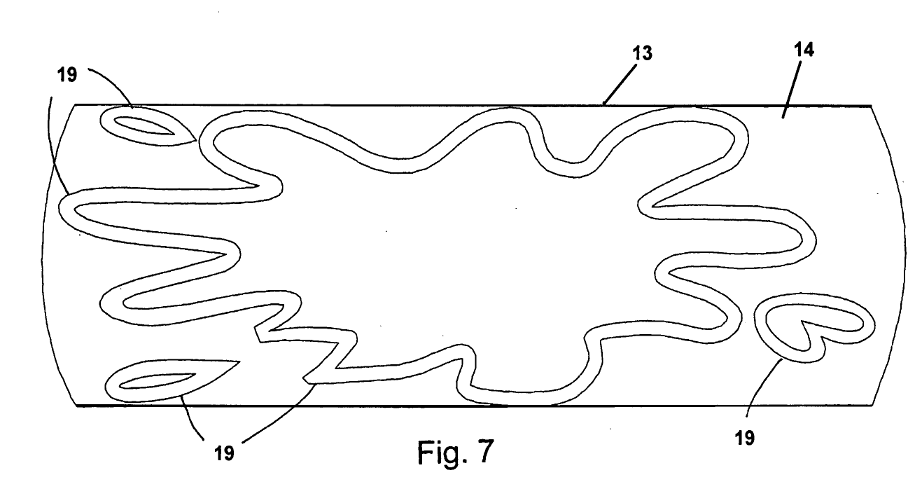

FIG. 7 depicts indicia 19 formed using the device 10 and method herein and shows a top plan view of indicia 19 in the form of a “Splash” design image outline typical of which may be produced with the device and method herein. The substrate 13 is shown as a case for an electronic device such as a computer product or back of a cell phone and the indicia 19 shows one design possible.

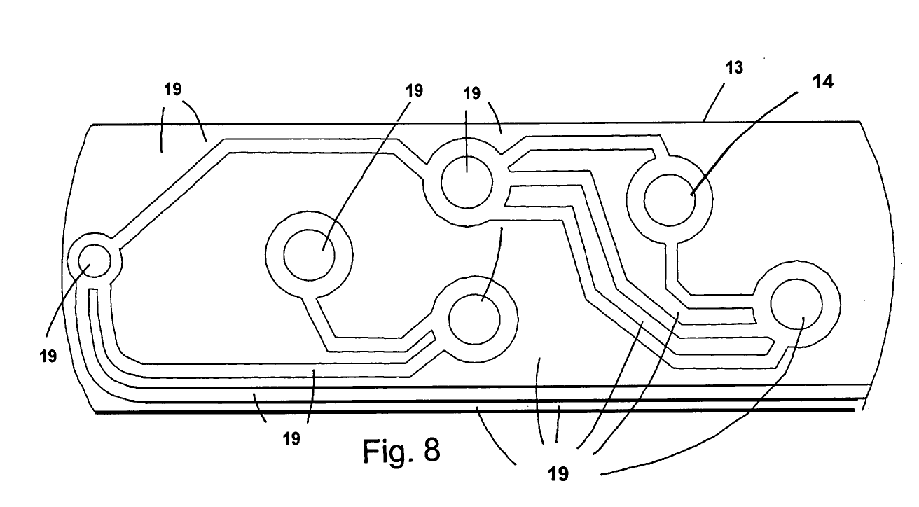

FIG. 8 depicts indicia 19 formed using the device 10 and method herein and shows a top plan view of indicia 19 in the form of a “PWBA”—printed wiring circuit board typical of which may be produced with the device and method herein. The substrate 13 would be provided by a conventional board and would be coated with the wet-film 14 on one planar surface wherein the circuit may placed with great accuracy by migrating and reorienting particles in the wet-film 14.

The indicia 19 formed by the device 10 and method herein, in a wet-film 14 as can be discerned by those skilled in the art, is not limited to decorative images, letters, numbers and logos. The indicia may also form antennas, bar codes, security codes, serial numbers, digital fingerprints or copyright information that may or may not be readable by the naked eye, product tracking information for manufacturers, or any image or indicia which would occur to those skilled in the art reading this disclosure. Antennas formed of the positionable particles 11 may be formed in an infinite number of shapes and with an infinite number and length of legs and as noted elsewhere need not necessarily be formed on a planar surface substrate 13. For instance, high definition antennas for televisions may be formed in a wet-layer covering the exterior of the television and have legs and sections formed using the device and method which will work well in one or a plurality of geographic areas depending on frequencies used in those locales. This would alleviate the need for the user to purchase an antenna. Product codes, indicia indicating origin point or authenticity of a product may be formed directly into a wet-layer 14 covering a product housing or other component 21 surface providing the substrate 13. This would greatly enhance product tracking, prevention of counterfeiting and enhance the ability to ascertain if a product is gray-market, counterfeit, or authentic by imprinting indicia that is readily viewable or hidden or disguised in the wet-layer. Even automobiles may be imprinted in the exterior finish of the vehicle using the device and method so long as the paint employed has orientable particles 11 therein. As such, indicia 19 should be interpreted broadly to include all such decorative and functional features that may be formed using with the device and method herein using wet-films 14 containing positionable particles 11 on any surface.

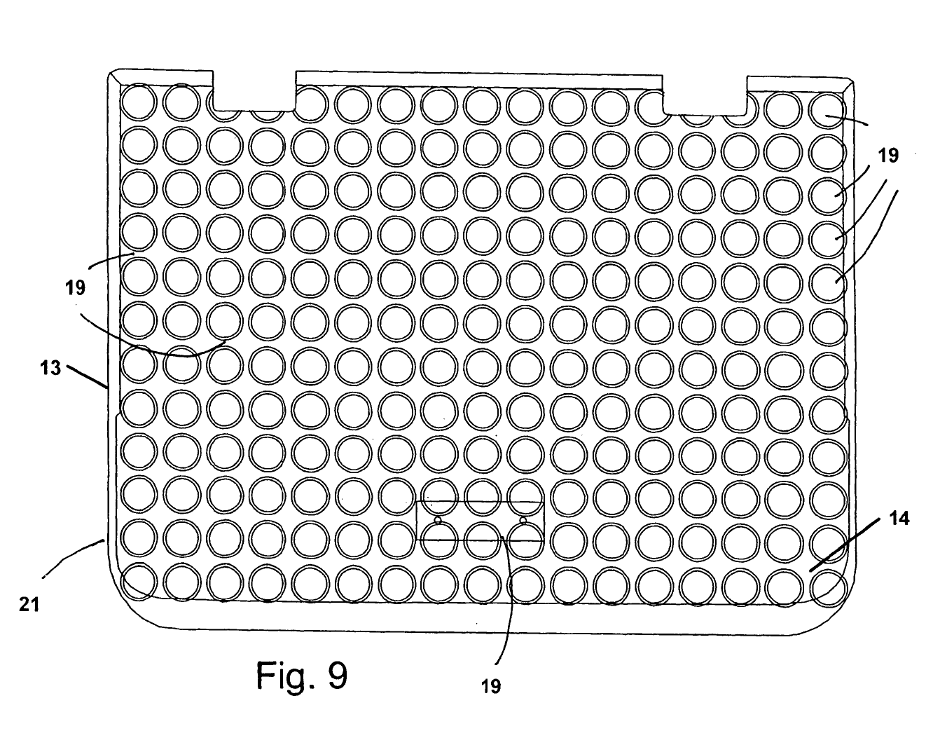

FIG. 9 depicts indicia 19 formed using the device 10 and method herein and shows a top plan view of such indicia 19 on a substrate 13 formed by an LCD DVD rear screen cover piece-part component 21 with a “Circles” pattern image outline typical of which may be produced with the device and method herein.

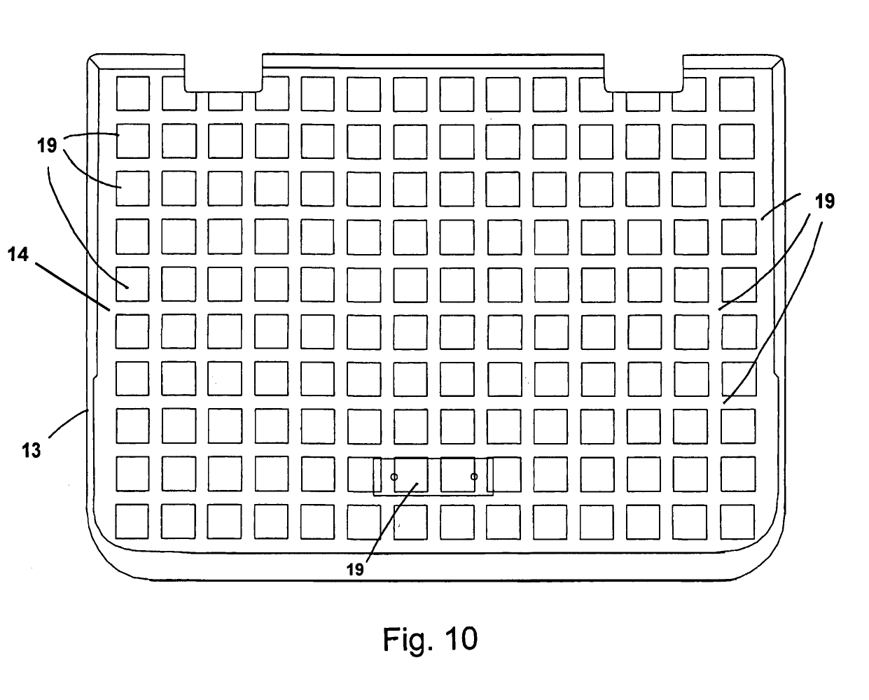

FIG. 10 is a top plan view of indicia 19 on a substrate 13 formed by an LCD DVD rear screen cover piece-part component 21 with a “Squares” pattern image outline typical of which may be produced with the device and method herein.

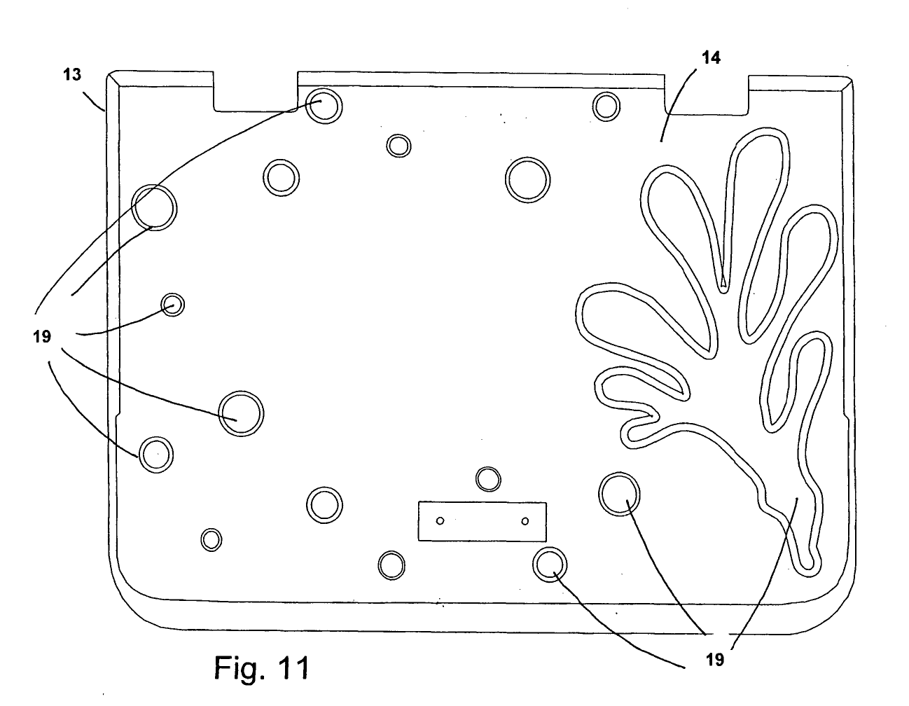

FIG. 11 depicts indicia 19 formed using the device 10 and method herein and such indicia 19 on a substrate 13 formed by an LCD DVD rear cover piece-part component 21 with “Seascape” design image outline typical of which may be produced with the device and method herein in the wet-film layer 14 which then dries.

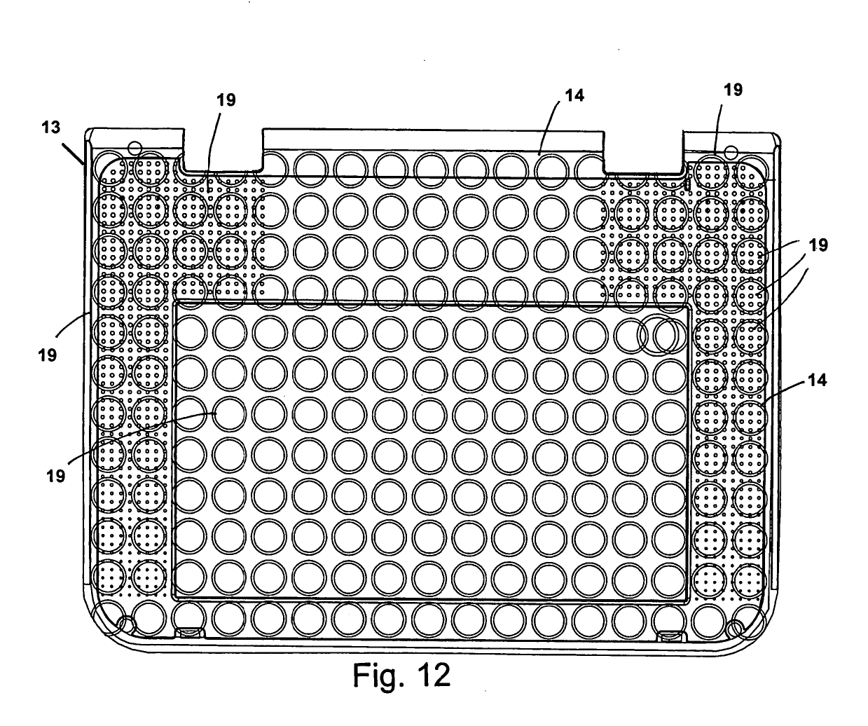

FIG. 12 is a top plan view of indicia 19 formed on a substrate provide by an LCD DVD front cover piece-part component 21 showing a “Circles” pattern image imparted by the induction tool 16 with a second design superimposed or overlaid typical of which may be produced with the device and method herein.

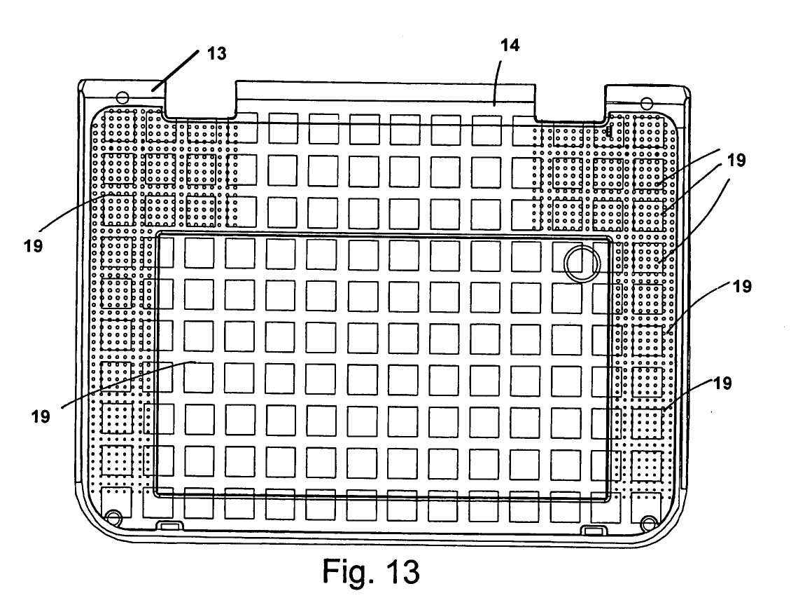

FIG. 13 depicts indicia 19 formed using the device 10 and method herein and shows indicia formed on a substrate 13 of an LCD DVD front cover piece-part component 21 with “Square” pattern image imparted to the particles 11 by the imaging tool 16 and magnetic field with a second design superimposed or overlaid typical of which may be produced with the device 10 and method herein.

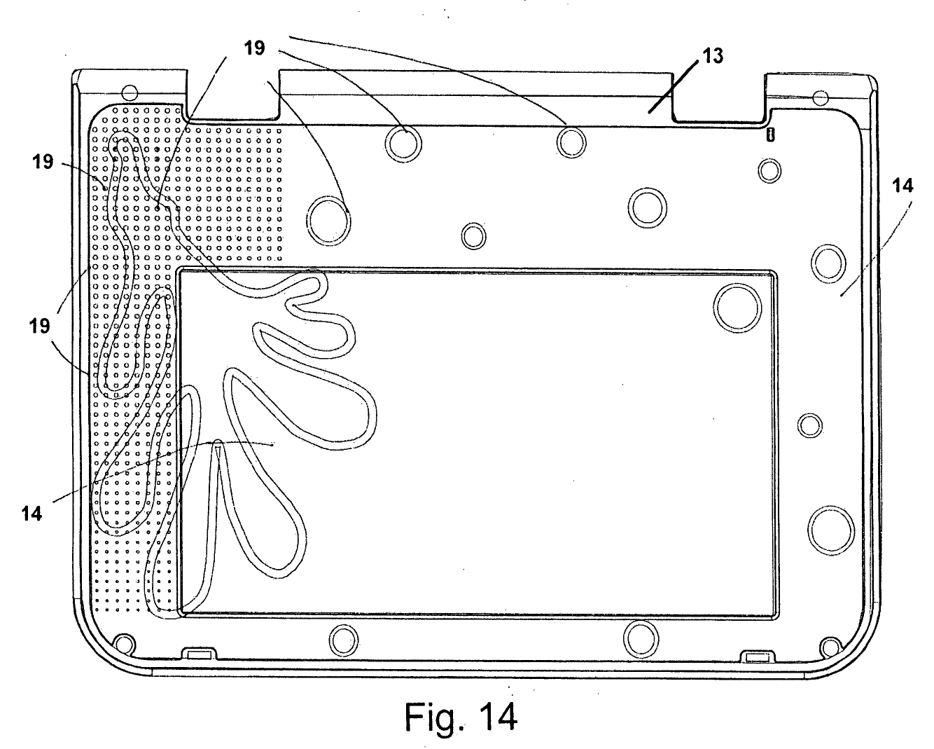

FIG. 14 shows is a top plan view of indicia 19 formed on a substrate 13 provided by the surface of an LCD DVD front cover piece-part component 21 showing a “Seascape” design image superimposed or overlaid, typical of which may be produced with the device 10 and method herein using the magnet 17 and imaging tool 16.

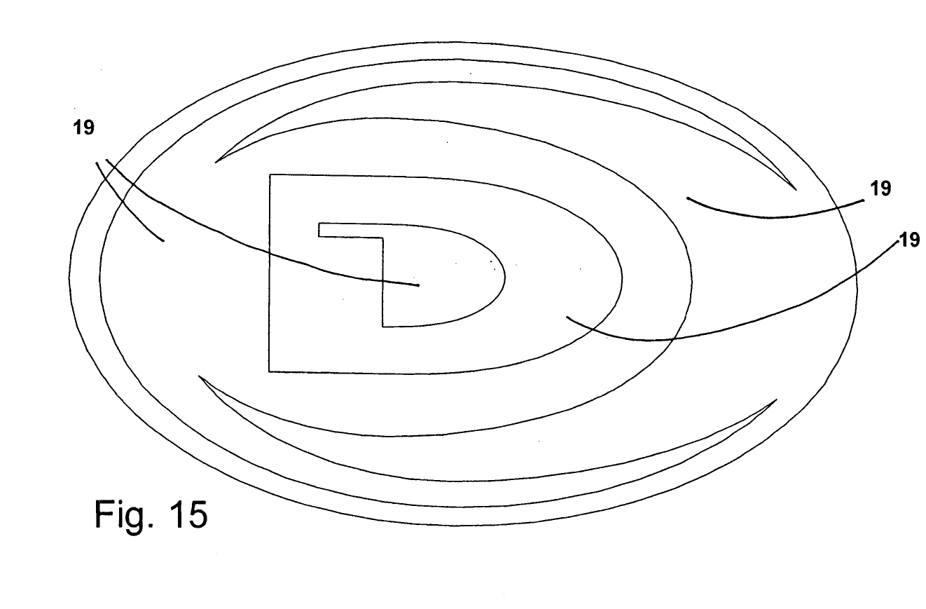

FIG. 15 depicts indicia 19 forming a typical “Logo” indicia 19 image typical of which may be produced with the device and method herein.

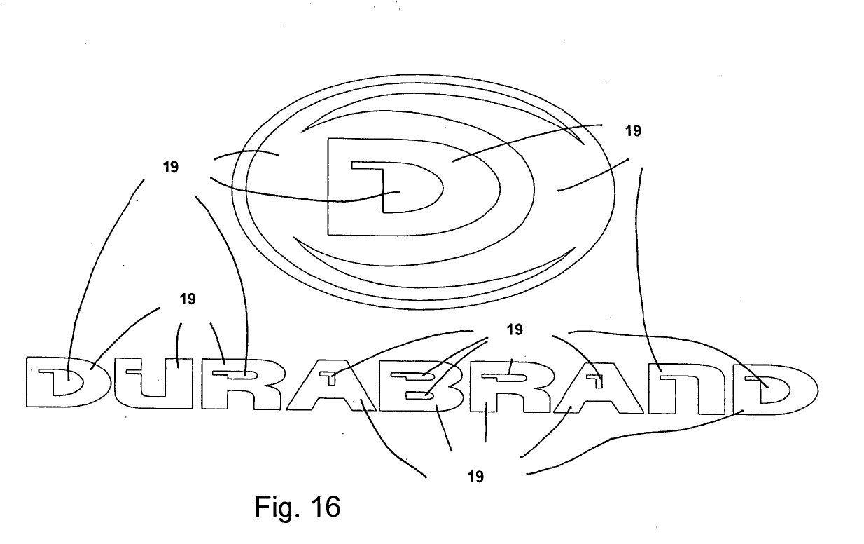

FIG. 16 is a top view of the “Logo” of FIG. 15 showing the addition of indicia 19 forming lettering denoting a brand name in parallel typical of which may be produced with the device and method herein through migration and orientation of the particles 11 as with the other designs shown.

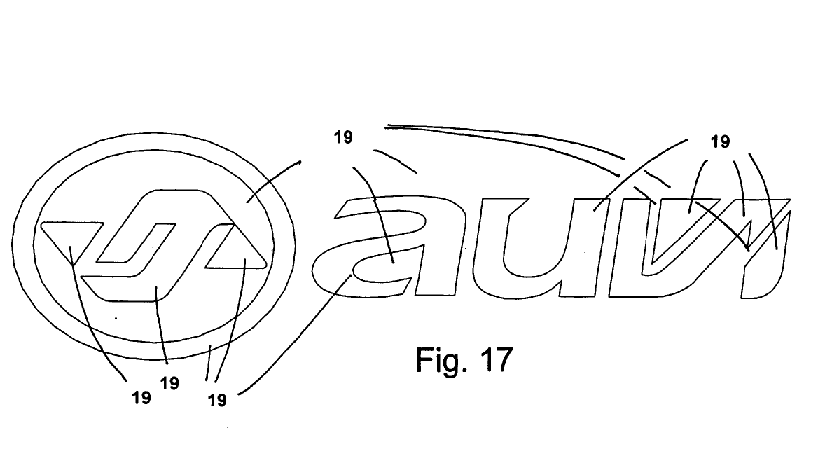

FIG. 17 is a top view of the “Logo” of FIG. 15 showing the addition of indicia 19 defining lettering denoting a brand name in series, typical of which may be produced with the device and method herein.

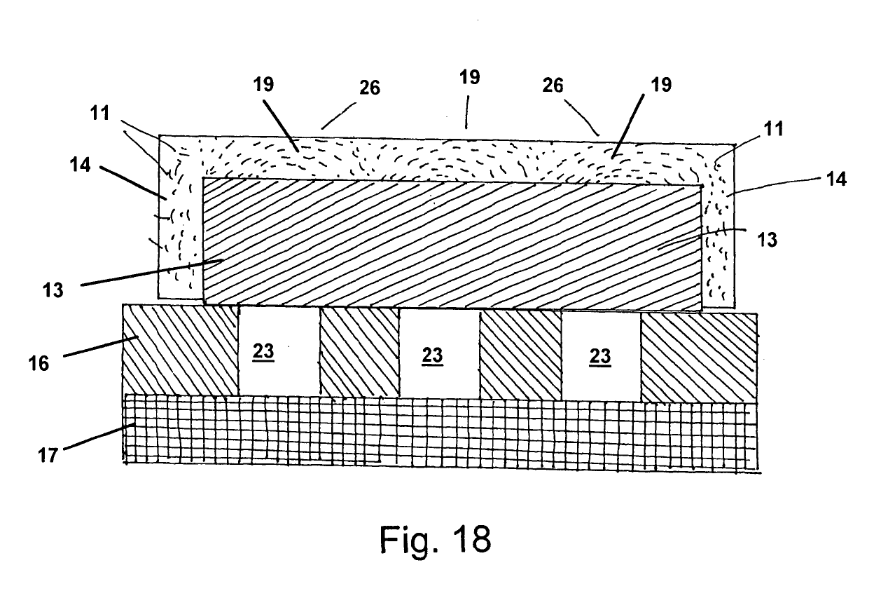

FIG. 18 is cross section depicting a piece-part component 21 forming the substrate with the resin forming the wet-film carrier for the magnetically orientable particles 11 and showing the induction imaging tool 16 device herein communicating a field or charged forces of induction from an anisotropic and axial pole planar magnet 17 on underside side of substrate 13 Also shown is the induction imaging tool 16 and/or anisotropic and axial pole planar magnet sheets being dimensionally larger in both X and Y axis than piece-part component 21 forming the substrate 13.

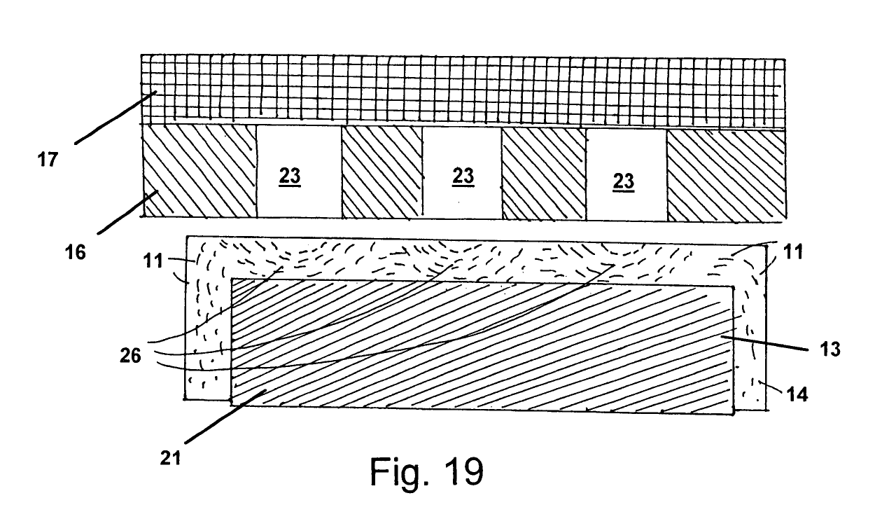

FIG. 19 is a cross section showing a piece-part component 21 forming a substrate 13 with the resin wet-film 14 containing the magnetically orientable particles 11 and depicting the induction imaging tool 16 focusing a communication of electrical charged forces of induction as lines 26 from anisotropic and axial pole magnet 17 sheets of various kinds on the upper or top side of substrate 13. Also shown is the preferred embodiment with the induction imaging tool 16 and/or anisotropic and axial pole planar magnet 17 being dimensionally larger than substrate 13, in both X and Y axis. Apertures 23 are shown communicating through the imaging tool 16 to focus the flux lines 26.

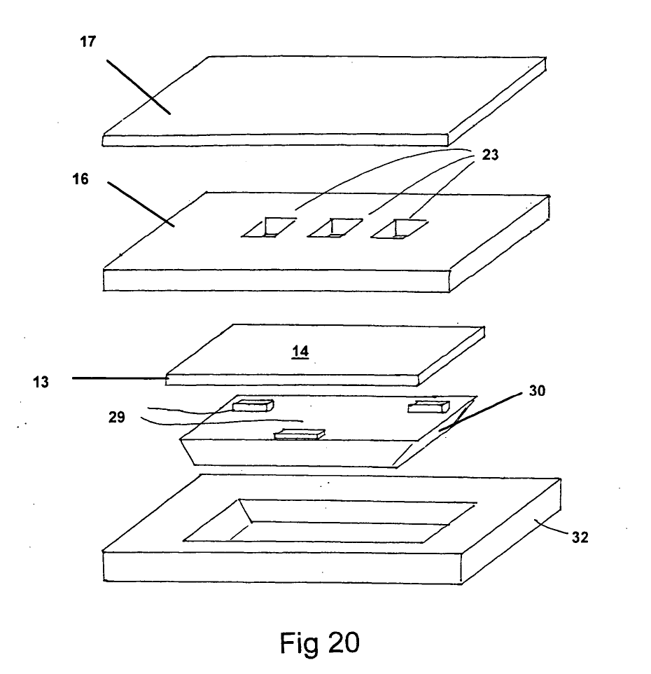

FIG. 20 is an exploded perspective view of an especially preferred embodiment of the device 10 herein showing the substrate 13 with the wet-film 14 containing the magnetically orientable particles 11 within the wet film 14 and showing the incorporation of the induction imaging tool 16 and resulting communication of electrical charged forces of induction from anisotropic and axial pole sheets or magnet 17 positioned on the same side of substrate 13 as the wet-film 14 and showing the induction imaging tooling and/or pole sheets being dimensionally larger than the substrate in both X and Y axis and showing substrate holding jig 30 having suctional ports 29 to hold the substrate 13 during imaging and a supporting base 32 adapted with angled side edges to engage with the jig 30 in a registered engagement during imaging to insure repeatable success.

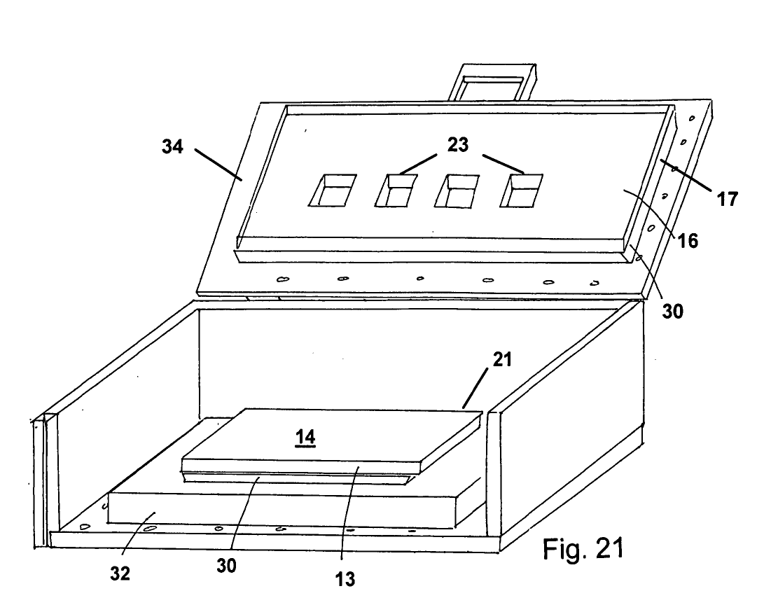

FIG. 21 is a perspective view of an off-line, work stand base with manual articulating lid 34, with supporting base 32, part jig 30, and the piece-part or component 21 providing a substrate and with the wet-film 14 containing the magnetically orientable particles. In this mode of the imaging tool device 10 herein repeatable images from indicia 19 imparted to the wet-film 14 on different substrates 13 are achievable using the articulating lid 34 to register the imaging tooling 16 and pole sheet magnet 17 in precise alignment, and a controlled proximity a distance from, the wet film 14 on the coated substrate 13.

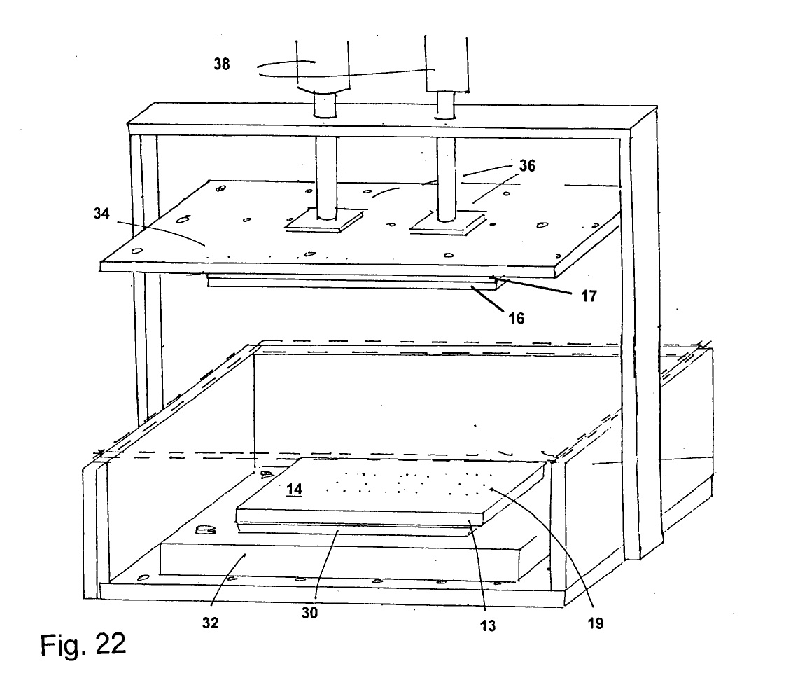

FIG. 22 is a perspective view of off-line, work stand employing a mechanically operated translating lid 34 engaged to the planar magnet 17 and adjacent planar imaging tool 16. A base 32 and jig 30 support the substrate 13 having a wet-film 14. The induction imaging tool 16 is shown in the preferred dimension of being larger than the substrate 13 in both X and Y axis. The lid 34 is engaged to a stand where it will register the imaging tool 16 and engaged planar magnet 17 in precise alignment, and a controlled distance from the wet-film 14 on the substrate 12. Means for translation of the imaging tool 16 closer or farther from the wet-surface 14 is provided by translating members 36 engaged to a hydraulic or electric translating cylinder 38 which may be adjusted to control the proximity of the imaging tool 17 to the wet-film 14 during the image process.

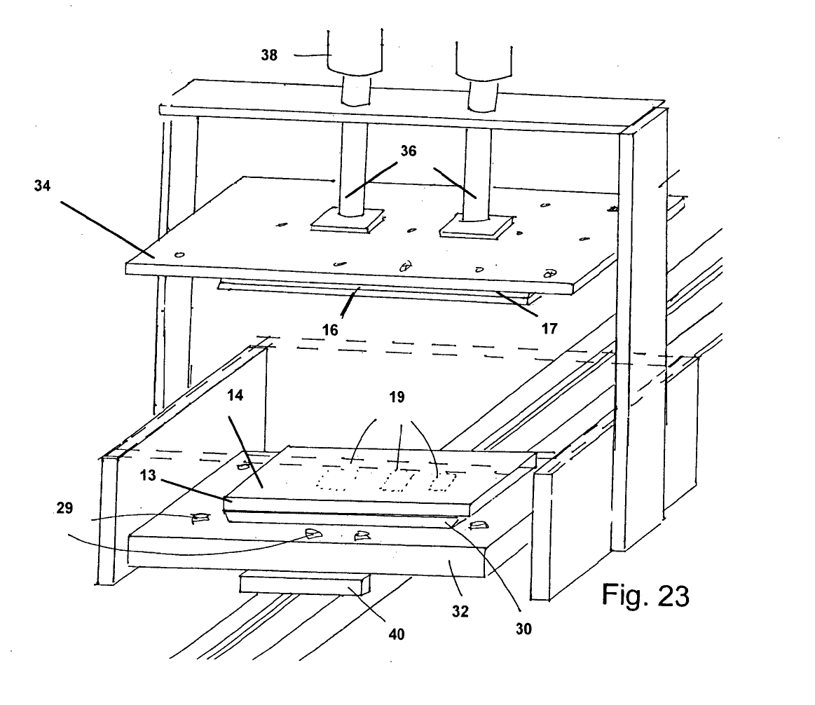

FIG. 23 is a perspective view of the mode of the device of FIG. 22 with the means for translation of the imaging tool 16 toward and away from the wet surface 14 a distance. Also included is in-line shuttle 40 or ball screw positioning table type base 32 which will register in position underneath the translating lid 34. Operation of the translating lid 34 registers the imaging tool 16 and pole sheets forming the planar magnet 17 in precise alignment and controlled proximity to the wet-film 14 on the substrate 13 for an automated, inline or lights-out operation with a camera QC/QA not shown.

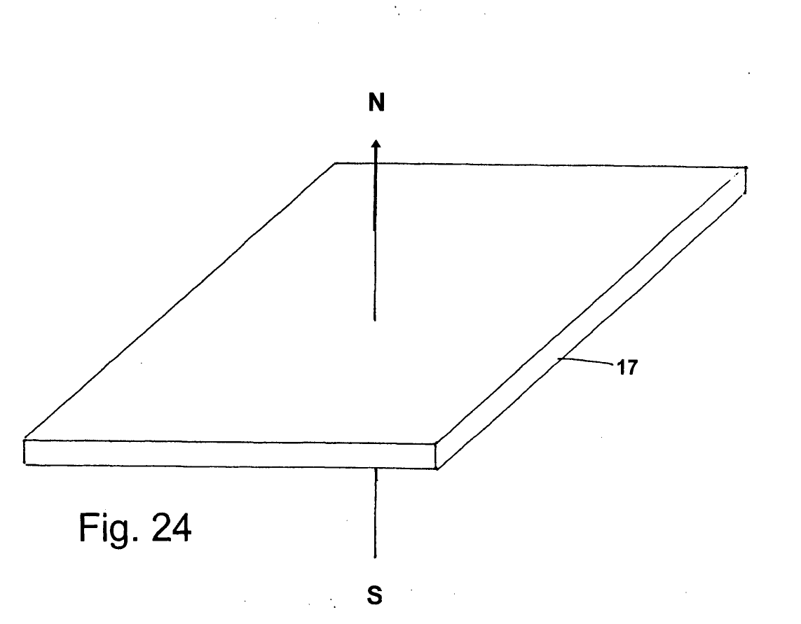

FIG. 24 is a perspective view of communication of electrical charged force of induction from anisotropic and axial as with a single pole per face planar magnet 17 as favored herein.

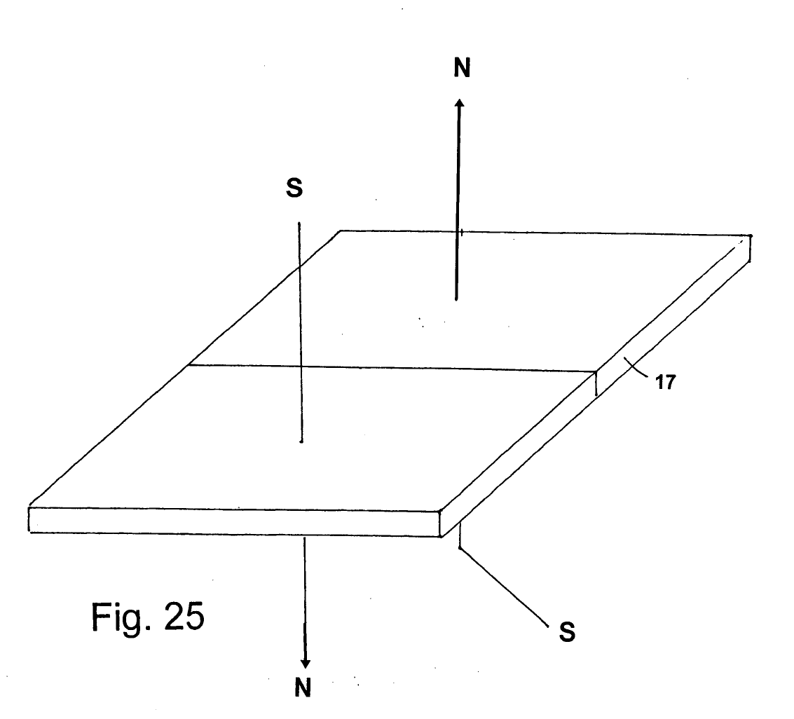

FIG. 25 is a perspective view of communication of electrical charged force of induction showing flow lines from anisotropic and axial with a two poles per face of a planar magnet 17 magnet as employed in the favored mode herein.

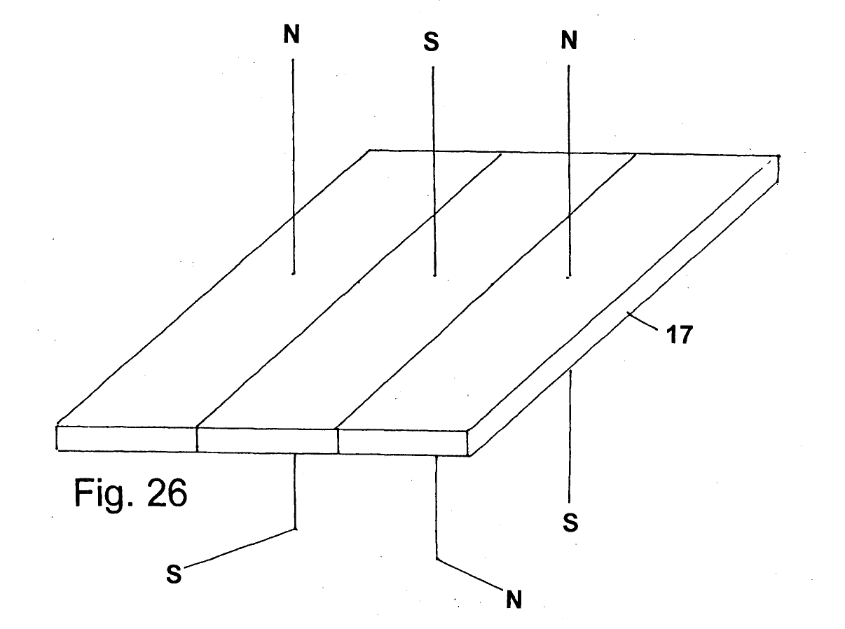

FIG. 26 is a perspective view of movement of electrical charged force of induction from anisotropic and axial with a three poles per face planar magnet as used herein.

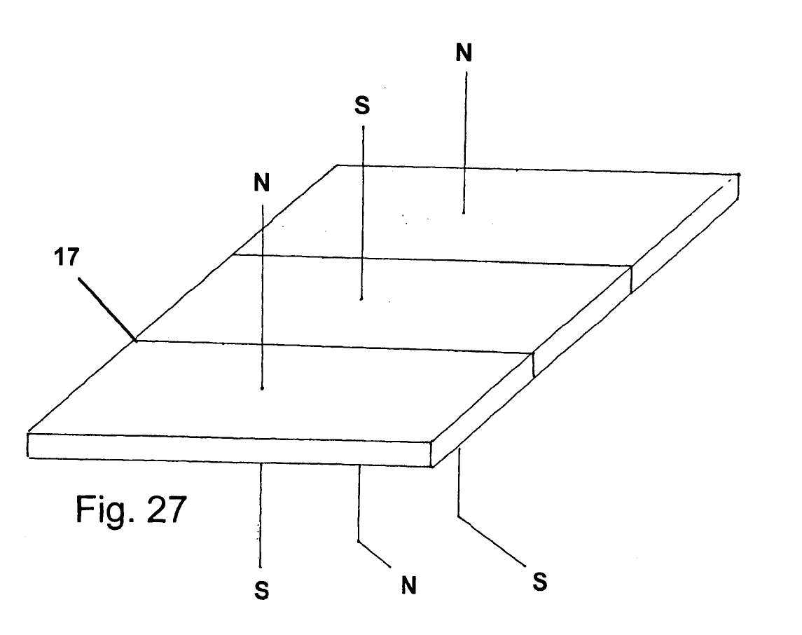

FIG. 27 is a perspective view of movement of electrical charged force of induction lines from anisotropic and axial with a three poles per face, opposite axis planar magnet as employed herein.

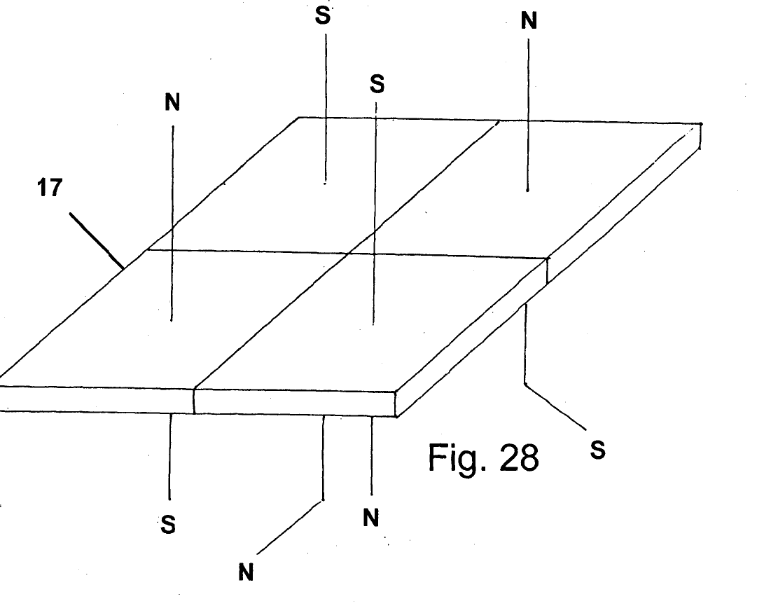

FIG. 28 is a perspective view of movement of electrical charged force of induction lines from anisotropic and axial with a four poles edge-centered per face planar magnet as used herein.

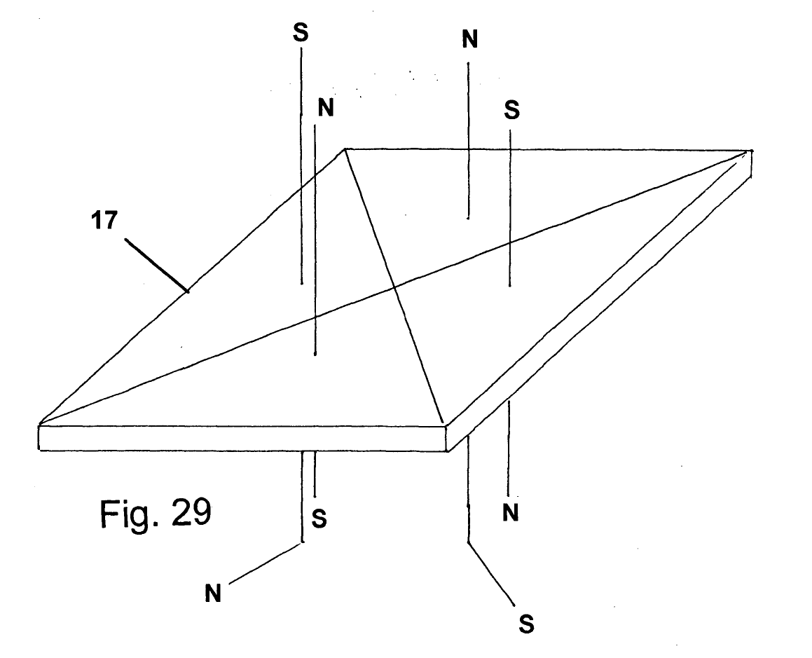

FIG. 29 is a perspective view of movement of electrical charged force of induction lines from anisotropic and axial with a four poles corner-centered per face planar magnet as employed herein.

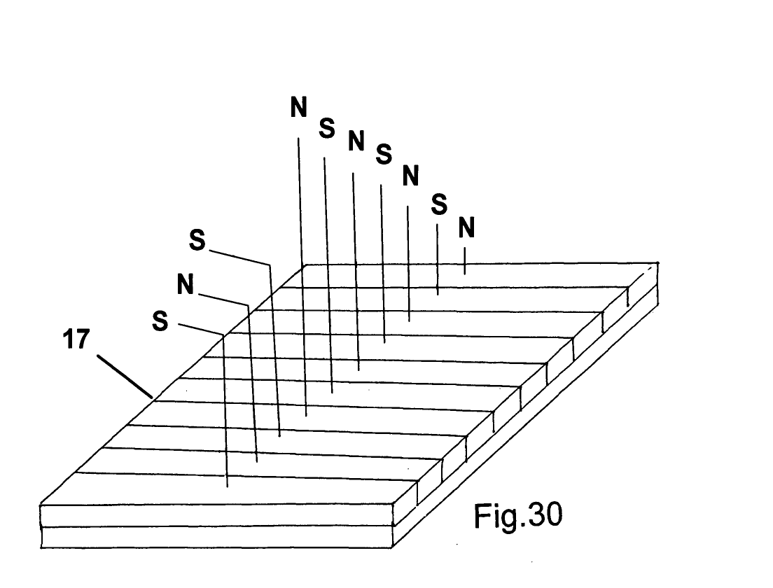

FIG. 30 is a perspective view of movement of electrical charged force of induction from a multiple-poles per face planar magnet 14 as would be employed with the device herein.

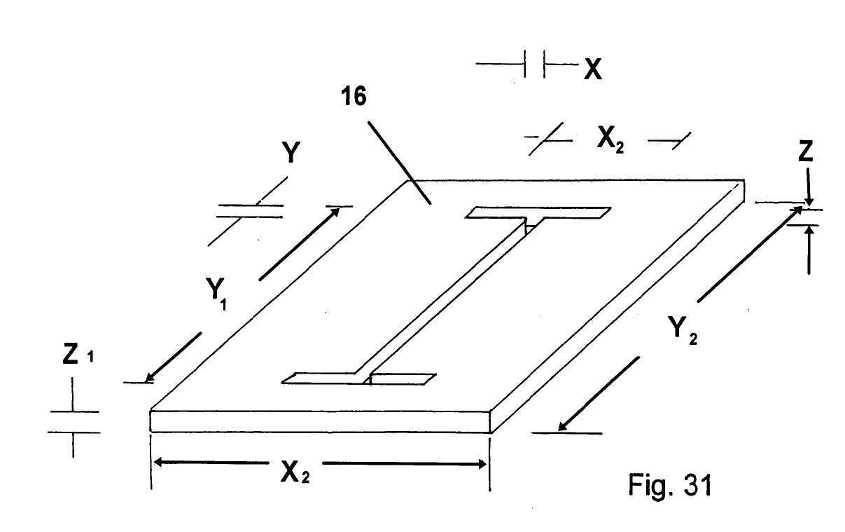

FIG. 31 is an perspective view of the indicia imaging tool 16 of cut metal as would be employed in the device 10 to focus the field lines from the magnet to orient the magnetically orientable particles 11 in the wet-film 14 for Letter “I”. It should be noted that positioning the magnet above or below the wet-film 14 in all modes of the device 10 using the planar imaging tool 16, will render the image convex or concave in its three dimensional view, depending on the polarity of the planar magnet 17 when so positioned and the field lines direction between the poles. Therefore a means to impart convex or concave viewed images is provided by this positioning of the imaging tool 16 and magnet 17 and determining the flow of the flux or field lines through the wet-film 14 based on the flow from the magnet 17 poles.

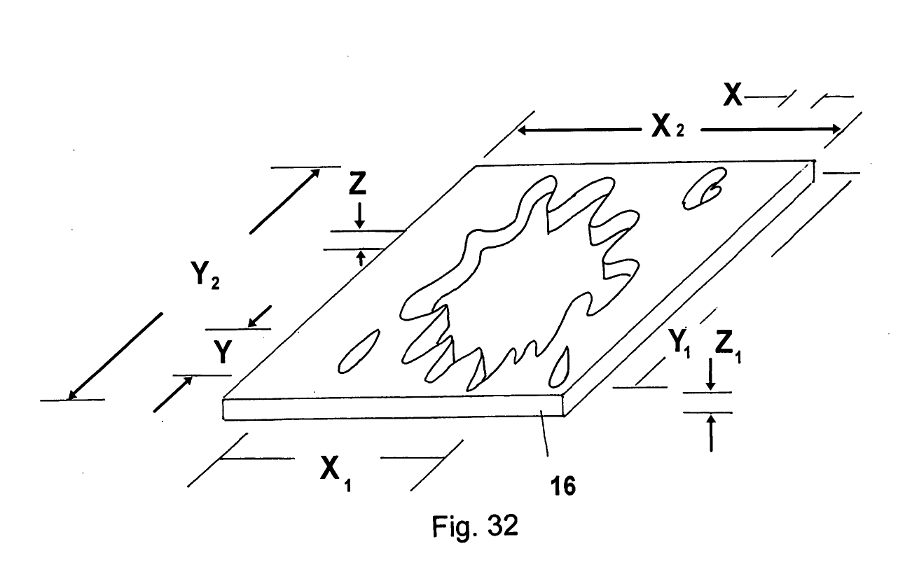

FIG. 32 is a perspective view of the indicia imaging tool as would be employed to orient the magnetically oriented particles in the wet-film to form a “Splash” design.

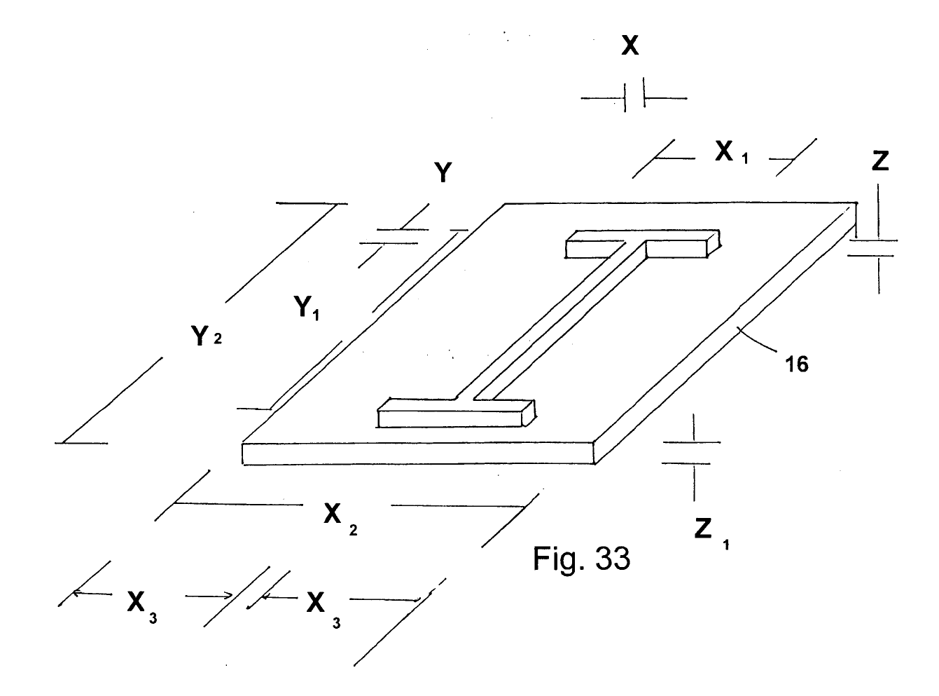

FIG. 33 is a perspective view of the indicia imaging tool 16 as would be employed to orient the magnetically oriented particles 11 in the wet-film 14 to render indicia 19 in the form the Letter “I” in a reverse or concave effect. Projecting the image to be formed from the planar sheet forming the imaging tool 16 as shown in FIG. 33 is another way to achieve the concave effect in the indicia 19.

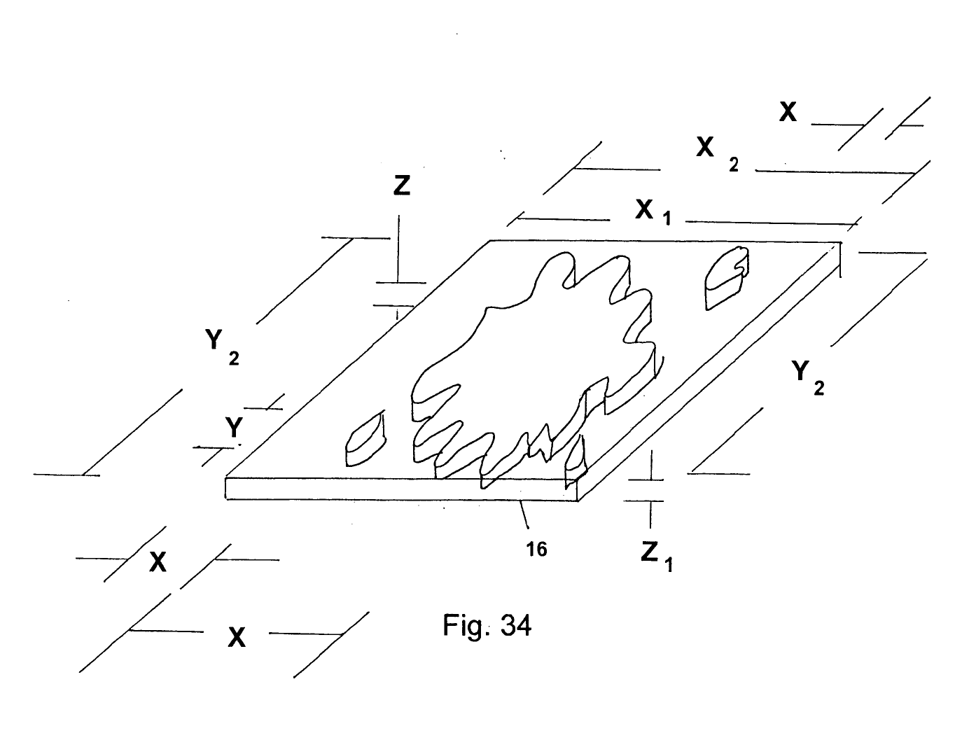

FIG. 34 is a perspective view of the indicia imaging tool 16 as would be employed to orient the magnetically oriented particles in the wet-film 14 to depict the “Splash” in a reverse or concave effect when viewed after drying.

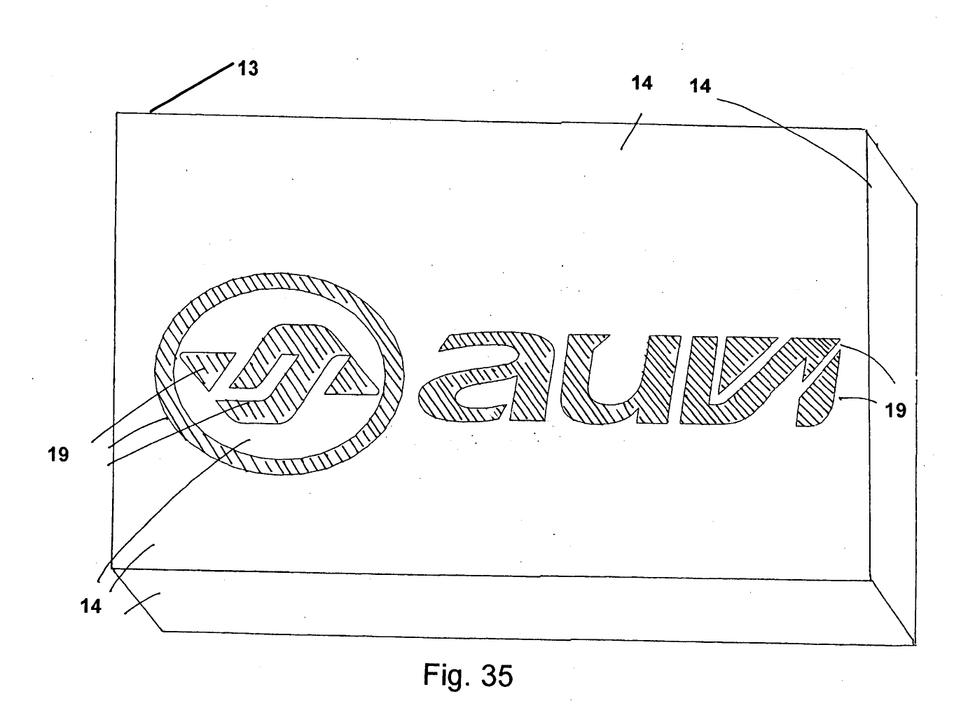

FIG. 35 is a top perspective view of an exemplar “Auvi” design logo and letters formed by the indicia 19 in the wet-film 14 covering a substrate 13 by the method and apparatus herein. Using the favored dimensions of the planar imaging tool 16 and magnet 17 which are larger in both directions than the dimension of the substrate 13, provides a means to produce indicia 19 which is sharp and with the background around the indicia 19 in the wet-film, substantially undisturbed.

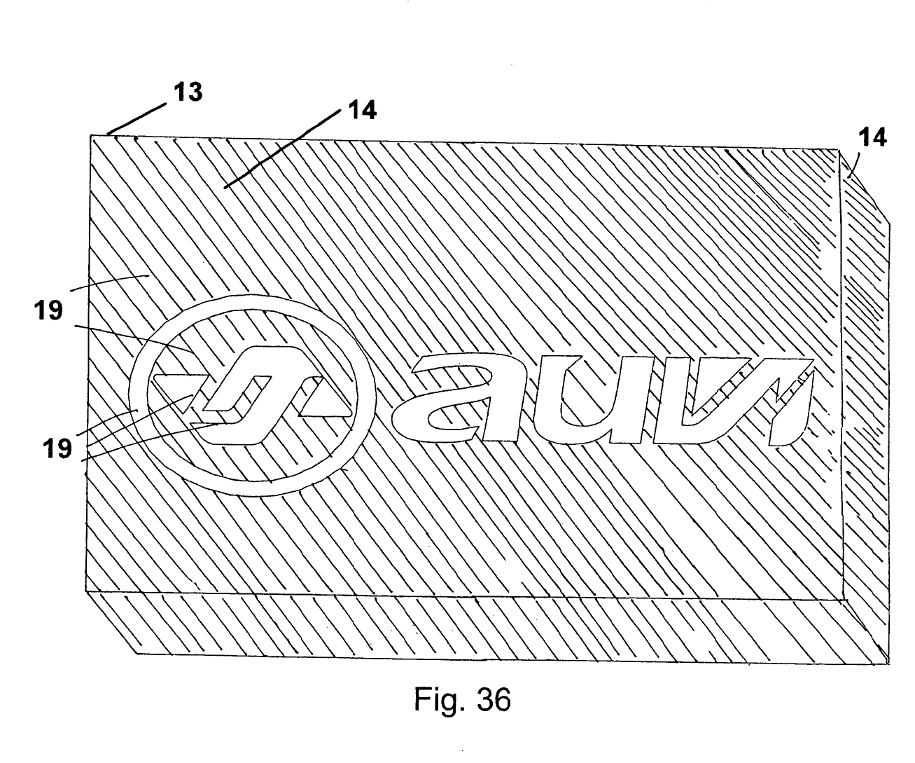

FIG. 36 is a top perspective view of the “Auvi” design logo of FIG. 35 in a second design option wherein employment of the larger dimensioned imaging tool 16 and planar magnet 17 will orient only the particles 11 surrounding the indicia 19 to form the logo and lettering. The clean reverse depiction of the logo and lettering is only achievable using the larger planar imaging tool 16 and magnet 17 as noted herein and is a significant improvement.

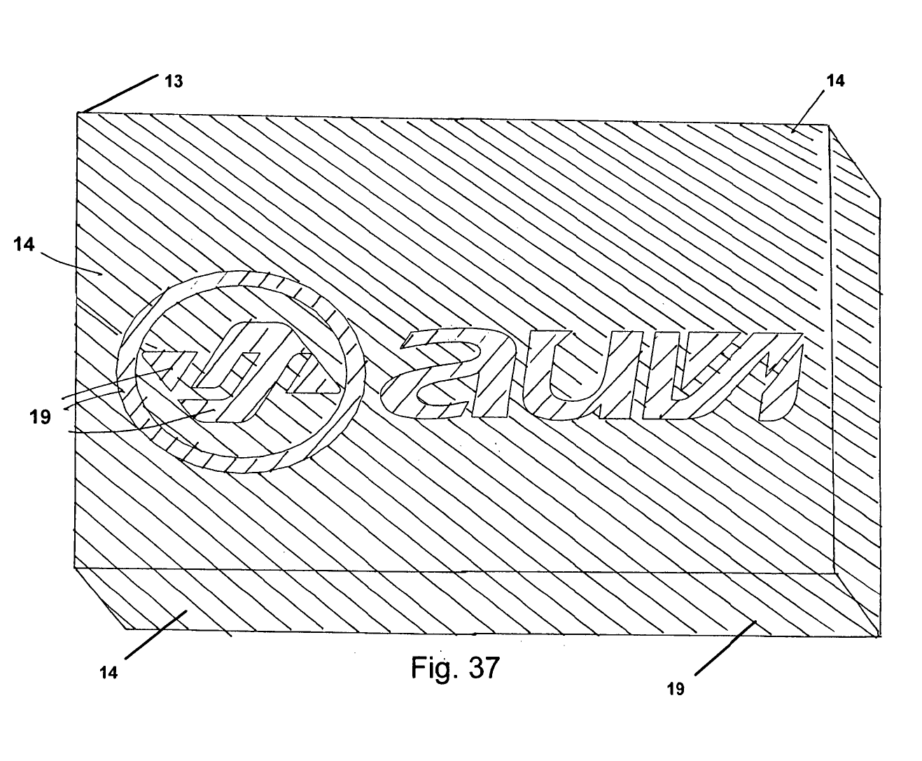

FIG. 37 is a top perspective view of the “Auvi” design logo of FIG. 35 in a third design option producible by the method and apparatus herein wherein the particles 11 forming indicia 19 of letters and logo are oriented in one manner and the particles 11 of the wet-film 14 of the background area are oriented in another manner to form the design. The larger imaging tool 16 and magnet 17 are the breakthrough in design that allowed for this type of indicia 19.

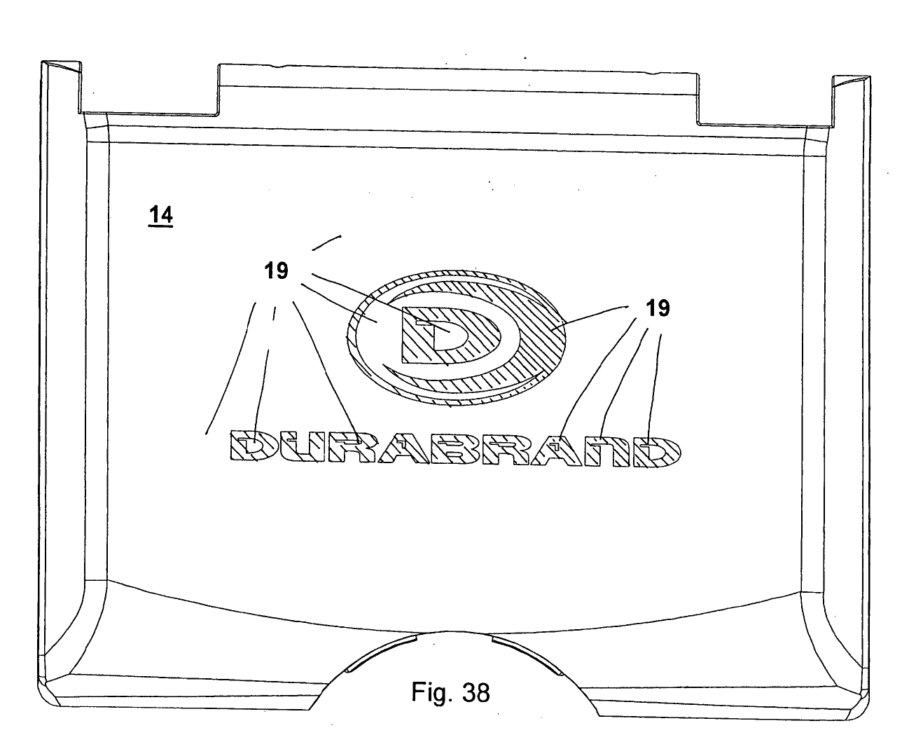

FIG. 38 depicts a top perspective view of indicia 19 forming a “Durabrand” Logo and letter name produced in the first design option or particle orientation as in FIG. 35 and achievable only with the dimensional characteristics of the planar imaging tool 16 and magnet 17 as to the size of the substrate 13.

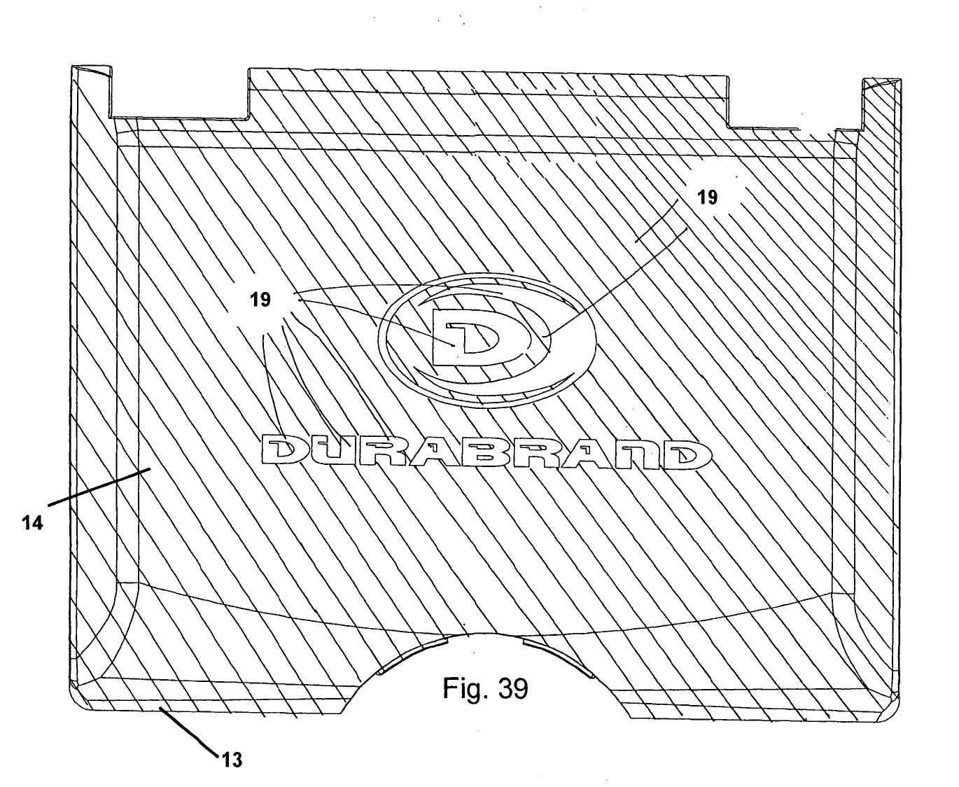

FIG. 39 depicts a top perspective view of indicia 19 forming the “Durabrand” Logo and letter name as in the second design option of particle orientation noted in FIG. 36 and employing the novel clarity of image provided by the dimensional relationship noted between substrate 13 and imaging tool 16 and magnet 17.

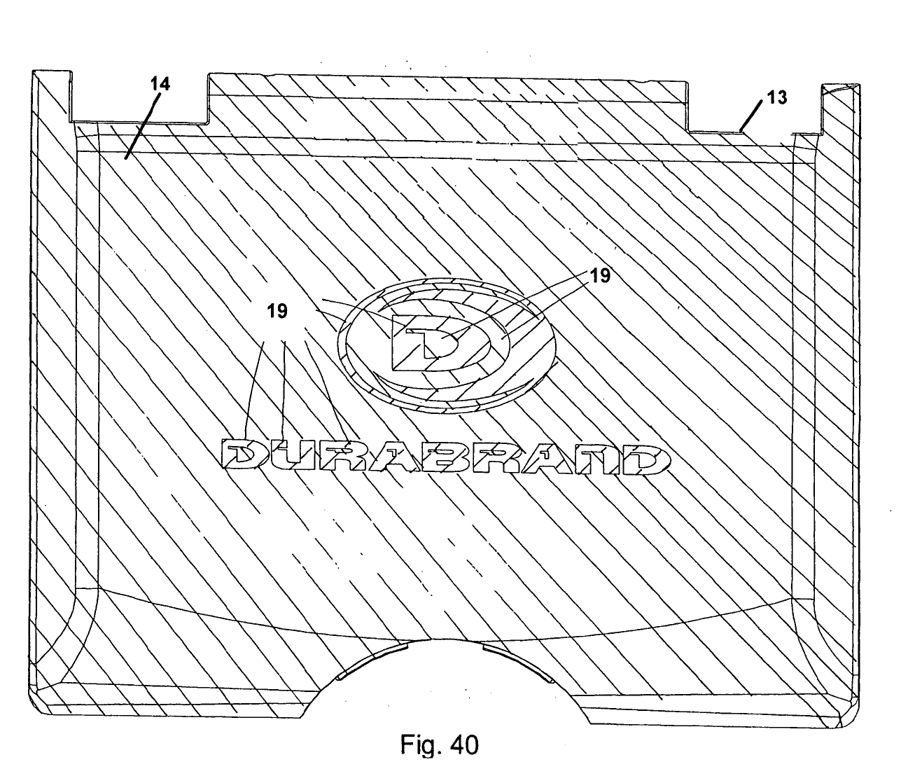

FIG. 40 depicts a top perspective view of indicia 19 forming the “Durabrand” Logo and letter name as in the third design option of particle orientation as in FIG. 36 enabled by the novel clarity of image produced by the dimensional relationship noted between substrate 13 and imaging tool 16 and magnet 17.

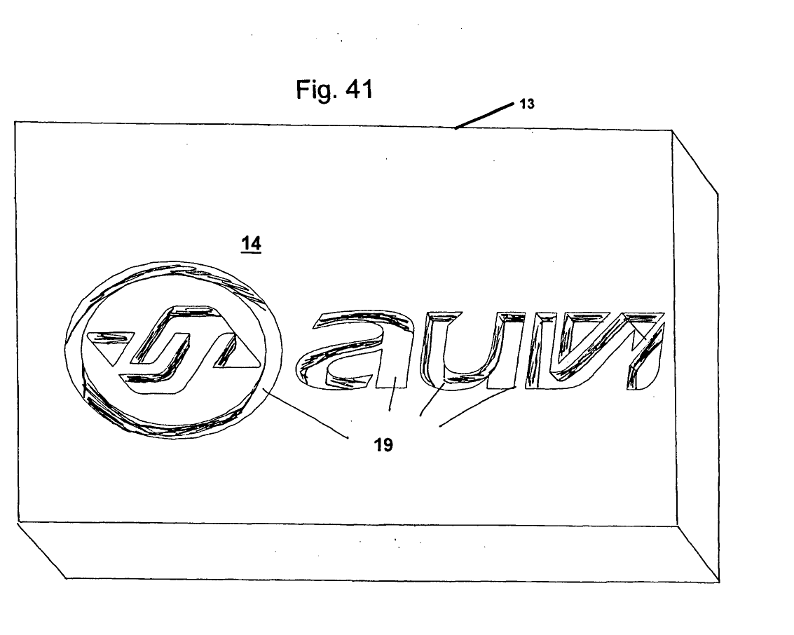

FIG. 41 is a top perspective view of indicia 19 forming the “Auvi” design logo and letter name in the first design option and using the cut metal imaging tool 16 to impart indicia 16 into the particles 11.

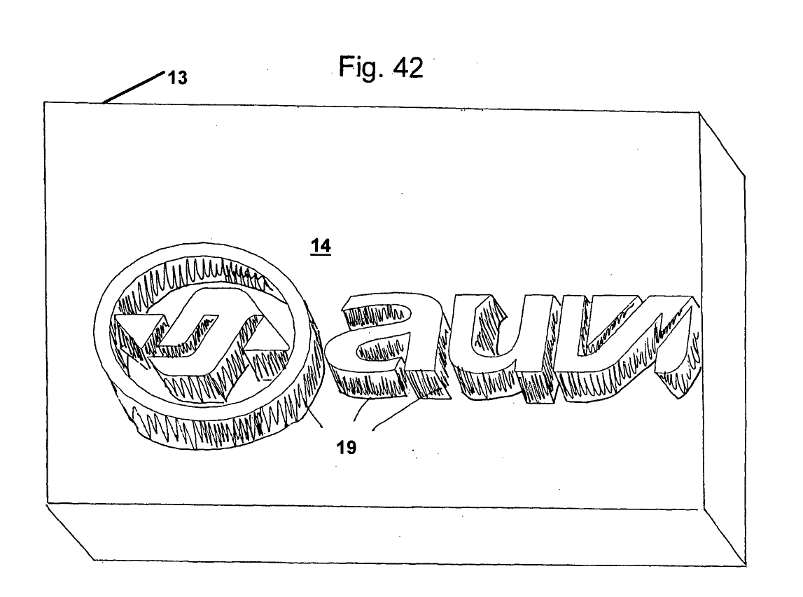

FIG. 42 is a top down slight angled view of indicia 19 forming the “Auvi” design logo and letter name employing the second design option noted above in FIG. 35 using the cut metal imaging tool 16 to impart indicia 19 to the particles 11.

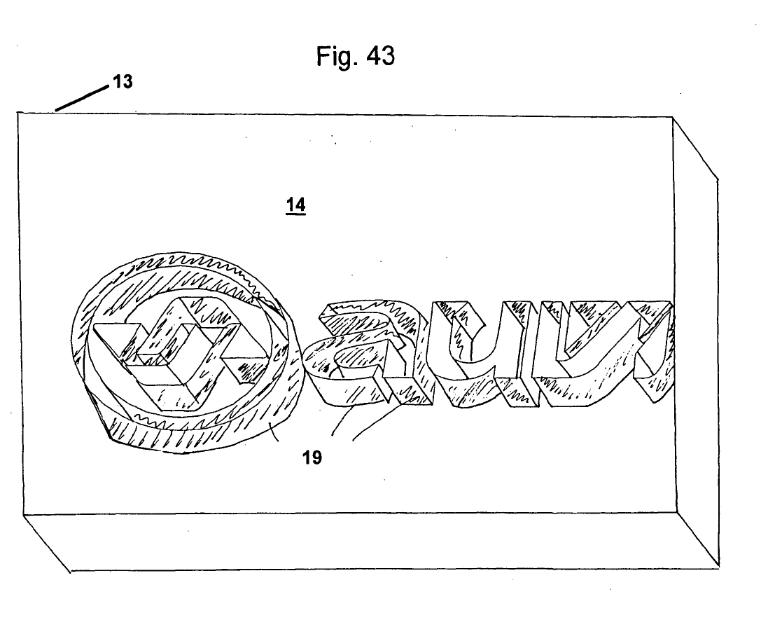

FIG. 43 is a top down slight angled view of indicia 19 forming the “Auvi” design logo and letter name in the third design option noted in FIG. 36 and using a cut metal tool to impart indicia 19 to the particles 11 in the wet-film 14.

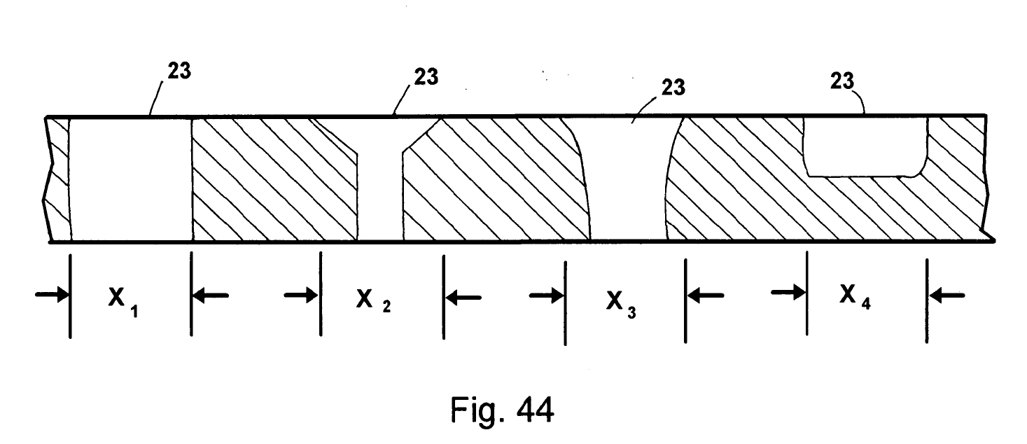

FIG. 44 is a cross sectional view of the disclosed metal imaging tool to impart indicia by orienting the particles suspended in the wet-film design with varying dimensions of the formed paths in the planar tool to orient the particles in the wet-film to vary the degree or level of the viewed indicia on the substrate while maintaining overall indicia dimensions.

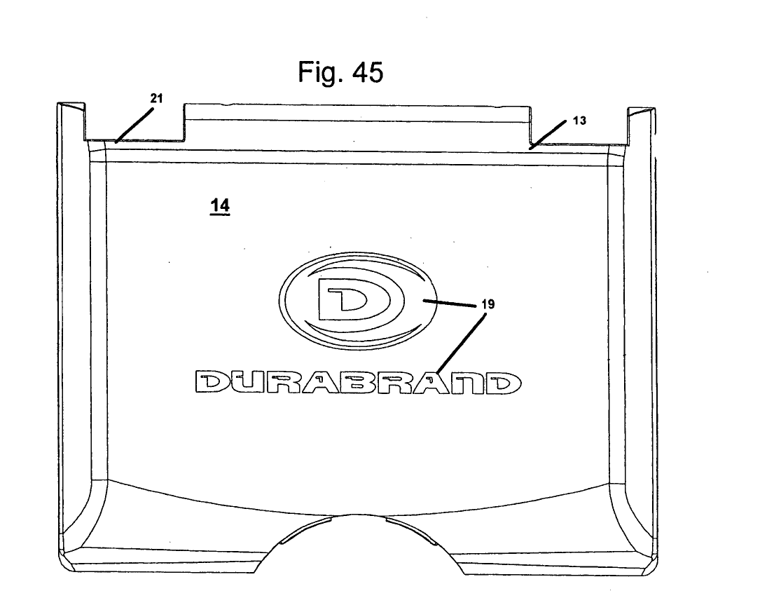

FIG. 45 is a top plan view of indicia 19 forming the “Durabrand” Logo and letter name indicia as may be formed by particle 11 orientation in the wet-film 14 covering a substrate 13 by the method and apparatus herein where the substrate is a DVD LCD or laptop computer rear piece-part component 21 forming part of the housing.

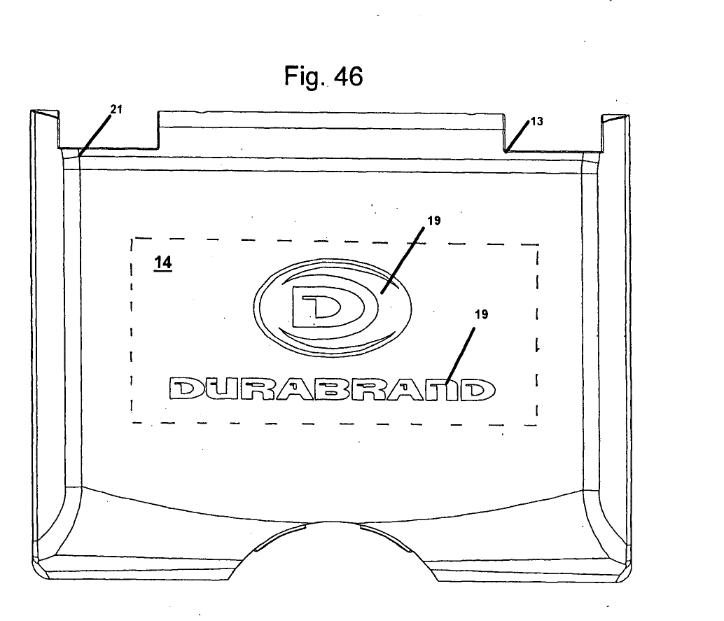

FIG. 46 is a top down view of indicia 19 forming a “Durabrand” Logo and letter in the wet-film 14 covering a substrate 13 of FIG. 45 imparted by the method and apparatus herein viewed at an angle substantially perpendicular to the DVD LCD or laptop rear piece-part component 21.

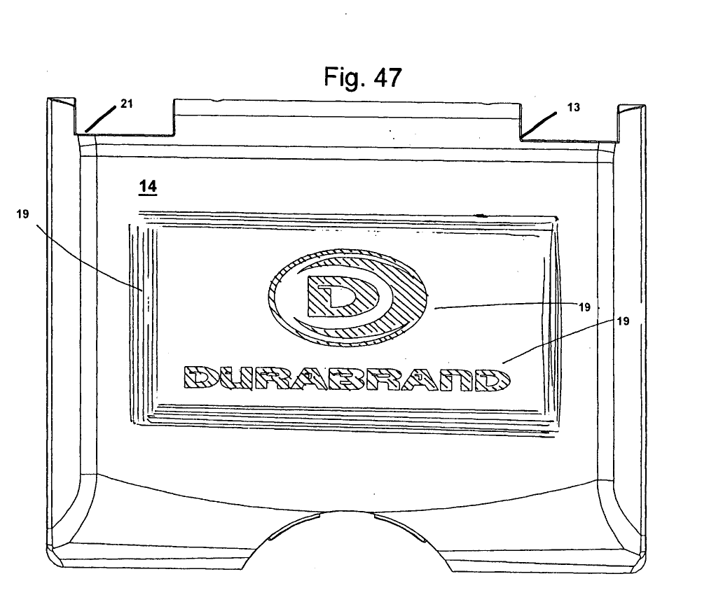

FIG. 47 is a top down view of indicia forming a “Durabrand” Logo and letter name as in FIG. 45 but viewed at a non-perpendicular angle to the surface of the rear piece-part component with outline of design imaging showing the achievable three-dimensional or spatial effects from orienting the particles at varying angles to the substrate 13.

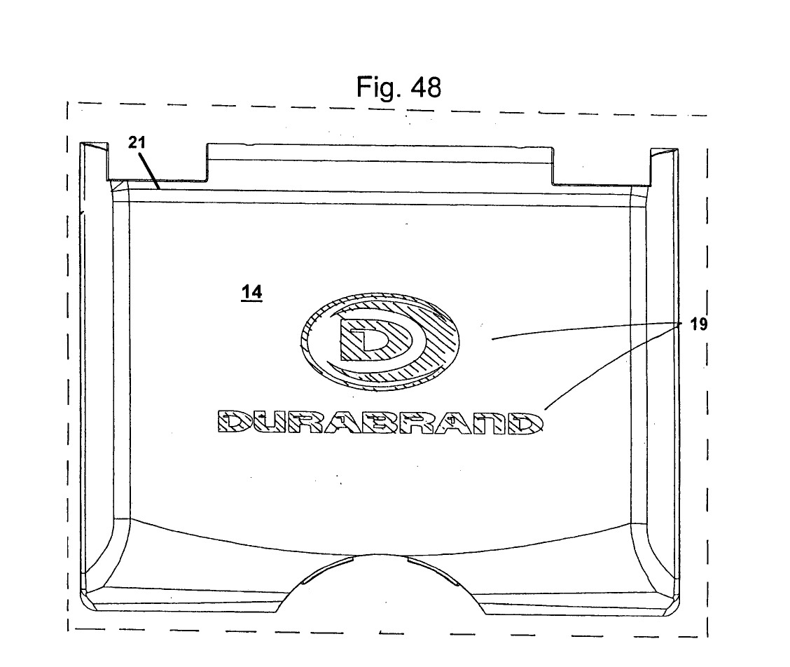

FIG. 48 is a top down view of indicia 19 formed to show a “Durabrand” Logo and letter name on a substrate such as an DVD or LCD or Laptop rear piece-part component 21.

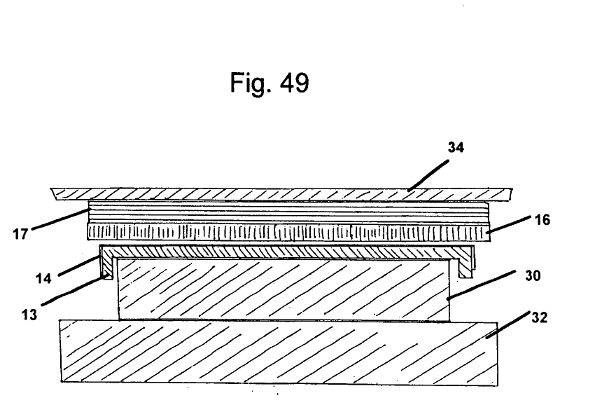

FIG. 49 is a simplified cross sectional view of work stand having a base 32, support jig 30 for a substrate 13 of a piece or component 21 of a manufactured item such as a laptop computer. A plurality of axial pole sheet type magnets 17 are positioned adjacent to the imaging tool 16 and both are engaged to a lid 34 which may translate closer or further from the wet-film 14 on the substrate 13 to adjust depth of field and sharpness of the produced image from indicia 19 formed by orienting particles 11. As shown, the induction imaging tool 16 is placed proximate but not touching the wet-film 14 on the substrate 13 and the particles 11 are induced by the magnetic flow to align to different angles to form the indicia 19. The lid 34 shown in other would hold the magnet 17 and imaging tool 16, and allow for a timed exposure of the magnetic field to the substrate 13 and wet-film 14. The process is repeatable in a high volume production mode heretofore unachievable with conventional magnetic imaging. With the magnet 17 oversized from the imaging tool 16 and placed above the substrate 13, the image will be directional toward the imaging tool 16 and will produce a directional flow of electrical charged forces of induction from anisotropic and axial pole sheets of magnets 17 of various kinds. This configuration can easily be reversed to get an inverse image by reversing the field generated by the magnet 14.

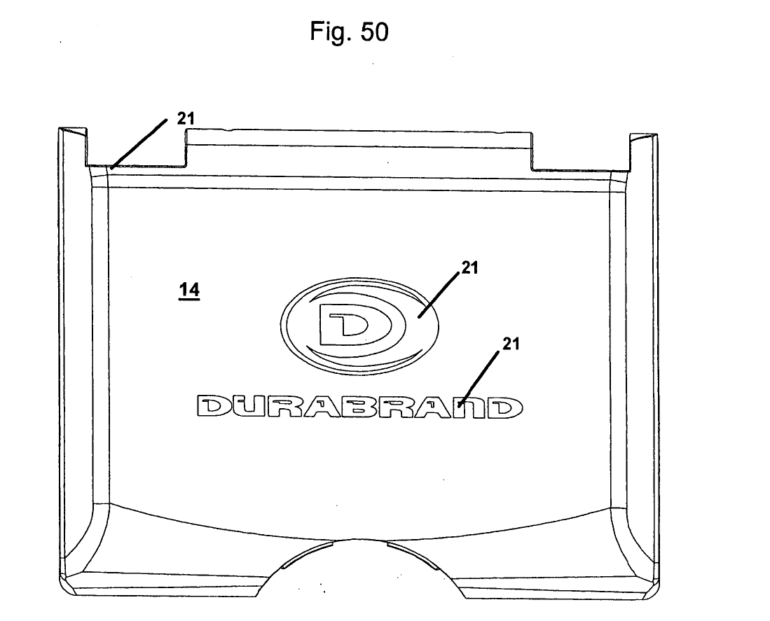

FIG. 50 is a top down view of example of DVD LCD or Laptop case, rear piece-part component 21 providing the substrate 13 to be held, secured, aligned and registered onto supporting work jig as in FIG. 49.

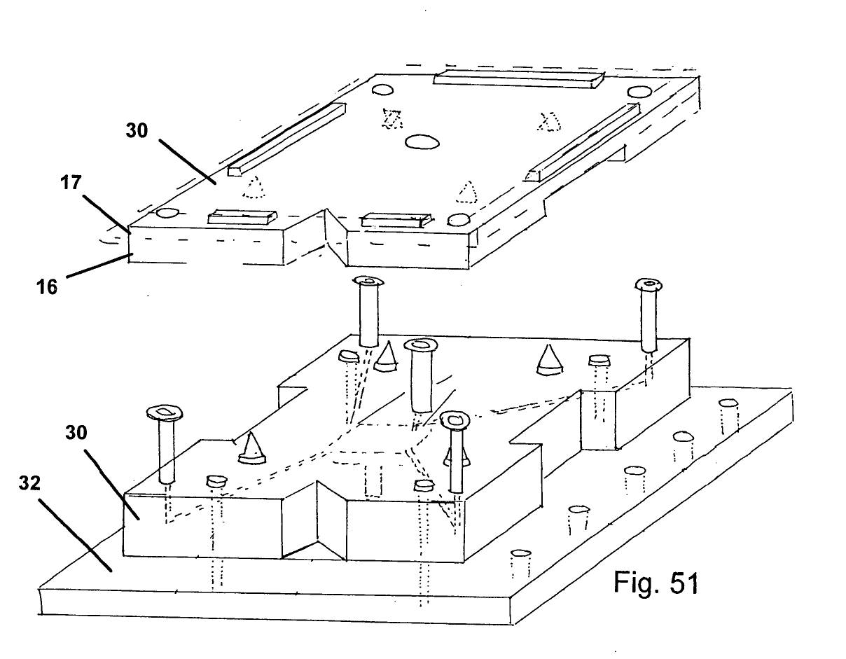

FIG. 51 is a perspective exploded view of a work base 32 and substrate supporting jig 30 for securing, locating, registering and aligning features for orientation of the particles to achieve the indicia of FIG. 49.

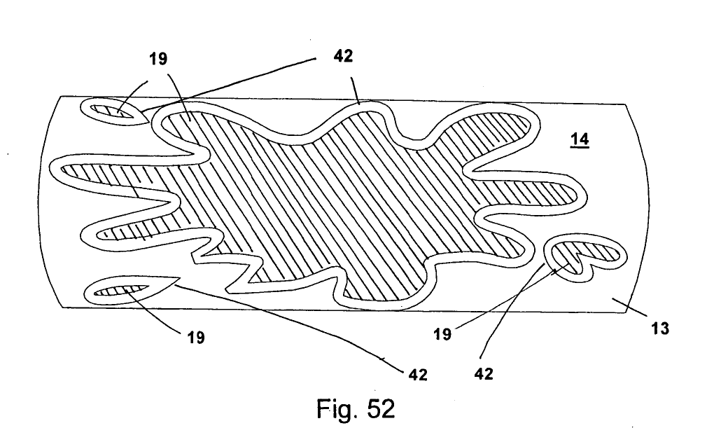

FIG. 52 is a top plan view of the “Splash” indicia 19 design formed by orienting the particles 11 in the wet-film 14 layer on the substrate 13 and with a laser etch outline 42. The device and method herein as noted provides for a major improvement in manufacturing components having three-dimensional magnetic images on surfaces. Using the unique magnetic sheet and smaller diameter tool, along with properly formulated coating material to enhance stabilized particles, production of components with such images can be greatly enhanced with the various configurations herein. Particularly notable are the frame and cover mode of FIG. 21 where parts to be imaged may be inserted and immediately removed. Also of particular note is the mode of fixture 22 and related figures. In this mode of the device and method, with enhanced coatings or conventional coatings without particle stabilization, the magnet and tool are engaged to a translating mount. This allows the magnet 17 and adjacent imaging tool 16 to be translated to an infinite number of distances from the surface being imaged which is in registered engagement on a jig 30. Thus image quality or sharpness may be adjusted by adjusting translation distance, toward and away from the surface being imaged, and when using stabilized particle coatings, the production times are greatly reduced.

Also of particular note is the vacuum hold down and registration system of FIG. 20 which features a jig 30 and supporting base 32 and means for alignment and registration using the angled engagement of the two, and employs a vacuum 29 for securing, registering and alignment of substrate piece-part or component 21. The surface being imaged would be in a wet filmed 14 state to allow migration or orientation of positionable magnetically influenced particles 11 within the film itself. Using this registration and vacuum hold down and the tooling herein described to produce the image, great increases in production and repeatable quality images are achievable.

As can be discerned by those skilled in the art, the device herein may be employed in a method to achieve high quality three-dimensional images and indicia on virtually any surface on a substrate 13 be it planar or contoured. In the method, from a steel plate, an imaging tool would be cut using laser or other means for cutting apertures in the plate to render the image desired in the wet-film 14 and eventually on the product. This planar steel plate provides an interface between the magnet 17 and the wet-film 14 to produce much higher quality indicia 19 than has been possible in prior art. Those skilled in the art will realize that many means exist for cutting and etching and engraving metal plate to form an image and any means for forming an image in the metal plate to render it an imaging tool 16 is anticipated in the scope of this invention.

Once the image has been imparted to the imaging tool 16, either in a projecting image to produce concave indicia in the applied wet-film 20 or as apertures to focus the field to produce the indicia 19 forming the image, the imaging tool 16 is mated to a planar magnet 16 having the appropriate number and types of poles to produce the three dimensional image intended. Of course it is important to produce both the imaging tool 16 and the planar magnet 17 in width and length dimensions larger than the size of the substrate 13 on which the image will be imparted into wet-film 14 appliqued to the substrate.

In a next step, the wet-film 14 composed of resinous material and magnetically oriented particles 11 is layered onto the substrate. Additives to maintain wetness and maintain the particles 11 in position on removal of the field may be added as well as an additive to prevent the particles from sagging on a vertically imaged substrate 13.

In a next step, the planar imaging tool 16 would be placed adjacent to the wet-film 14 to allow the field from the magnet 17 as focused by the imaging plate 16 to migrate and reorient the particles 11 to form the intended image in the wet-field 14.

If additives to maintain the particles 11 in place have been added to the wet-film 14 mixture employed in combination with the device 10 and method herein, the imaging tool 16 and magnet are removed and the substrate allowed to dry. However, if no additives are included in the mix, the imaging tool 16 and magnet 17 are maintained adjacent to the wet-field 14 till sufficiently dry.

The imaged substrate 13 may then be employed in the product such as a cell phone or laptop computer with the three dimensional image thereon. Of course formation of the tool 16 and operation of the imaging steps may be adjusted accordingly to include other noted operations or components or structure noted herein in subordinate or independent claims.

While all of the fundamental characteristics and features of the improved disclosed and described coating yielding detailed images using magnetic imaging with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A method of imparting indicia to a substrate having a wet-film layer with a mixture of resinous liquid and magnetically positionable particles on a first surface of said substrate, with a substantially planar magnet having two planar side surfaces and a planar imaging component having to planar sides, comprising the steps of:
forming indicia into said planar imaging tool thereby configuring it to interact with a magnetic field from said magnet to cause said particles in said wet-layer to migrate and orient along said magnetic field and impart said indicia into said wet layer as a rendition thereof formed by said particles;
abutting a side surface of said planar magnet to a first of said side surfaces of said imaging component to form an imaging component;
placing said imaging component, with a second of said side surfaces of said imaging tool opposite said first of said side surfaces, in an imaging position adjacent to said substrate and a distance therefrom;
maintaining said imaging component in said imaging position for a time duration sufficient for said rendition to form in said particles; and
allowing said wet-layer to dry and thereby fix said rendition in said wet-layer.

2. The method of imparting indicia to a substrate of claim 1 including the additional steps of:
forming said indicia into said planar imaging tool using apertures communicating between said first side surface and second side surface to thereby cause said renditions to appear three dimensional.

3. The method of imparting indicia to a substrate of claim 1 including the additional steps of:
forming said indicia into said planar imaging tool using projections from said second side surface and second side surface to thereby cause said renditions to appear three dimensional.

4. The method of imparting indicia to a substrate of claim 2 additionally comprising the steps of:
maintaining said imaging component in said imaging position adjacent to said wet-film on said first surface of said substrate to produce said indicia in a convex appearance.

5. The method of imparting indicia to a substrate of claim 3 additionally comprising the steps of:
maintaining said imaging component in said imaging position adjacent to said wet-film on said first surface of said substrate to produce said indicia in a concave appearance.

6. The method of imparting indicia to a substrate of claim 2 additionally comprising the steps of:
adjacent to a second side of said substrate opposite said first surface of said substrate to produce said indicia in a concave appearance.

7. The method of imparting indicia to a substrate of claim 3 additionally comprising the steps of:
adjacent to a second side of said substrate opposite said first surface of said substrate to produce said indicia in a convex appearance.

8. The method of imparting indicia to a substrate of claim 4 additionally comprising the steps of:
adjacent to a second side of said substrate opposite said first surface of said substrate to produce said indicia in a convex appearance.

9. The method of imparting indicia to a substrate of claim 1 additionally comprising:
providing a means to prevent said indicia from forming in areas of said wet-film which are a background to said indicia through the steps of:
employing a said planar magnet having a length and width, both of which exceed a respective length and with of said substrate; and
employing a said planar imaging component having a length and width both of which said respective length and width of said substrate.

10. The method of imparting indicia to a substrate of claim 2 additionally comprising:
providing a means to prevent said indicia from forming in areas of said wet-film which are a background to said indicia through the steps of:
employing a said planar magnet having a length and width, both of which exceed a respective length and with of said substrate; and
employing a said planar imaging component having a length and width both of which said respective length and width of said substrate

11. The method of imparting indicia to a substrate of claim 3 additionally comprising:
providing a means to prevent said indicia from forming in areas of said wet-film which are a background to said indicia through the steps of:
employing a said planar magnet having a length and width, both of which exceed a respective length and with of said substrate; and
employing a said planar imaging component having a length and width both of which said respective length and width of said substrate

12. The method of imparting indicia to a substrate of claim 4 additionally comprising:
providing a means to prevent said indicia from forming in areas of said wet-film which are a background to said indicia through the steps of:
employing a said planar magnet having a length and width, both of which exceed a respective length and with of said substrate; and
employing a said planar imaging component having a length and width both of which said respective length and width of said substrate.

13. The method of imparting indicia to a substrate of claim 1 additionally comprising:
providing a means to focus the indicia forming in areas of said wet-film through the steps of:
employing means to translate said imaging component to any of an infinite number of different said imaging positions each different said distances from said substrate.

14. The method of imparting indicia to a substrate of claim 2 additionally comprising:
providing a means to focus the indicia forming in areas of said wet-film through the steps of:
employing means to translate said imaging component to any of an infinite number of different said imaging positions each different said distances from said substrate.

15. The method of imparting indicia to a substrate of claim 9 additionally comprising:
providing a means to focus the indicia forming in areas of said wet-film through the steps of:
employing means to translate said imaging component to any of an infinite number of different said imaging positions each different said distances from said substrate.

16. The method of imparting indicia to a substrate of claim 10 additionally comprising:
providing a means to focus the indicia forming in areas of said wet-film through the steps of:
employing means to translate said imaging component to any of an infinite number of different said imaging positions each different said distances from said substrate.

17. A method for imparting an image to coating mixture for coating surfaces having a substantially clear resinous carrier component carrying a plurality of magnetically positionable particles, comprising the steps of:
imparting apertures to produce an image into a planar induction imaging component which communicate a width between two substantially parallel sidewalls of said imaging component;
positioning a magnetic field generating component having substantially parallel side surfaces separated by a width, with one of said side surfaces adjacent to one of said sidewalls to form an imaging component;
placing a layer of substantially clear resinous carrier material carrying a plurality of magnetically positionable particles, upon a surface to be imaged;
moving said imaging component adjacent to said surface for a duration of time to form an image with said particles; and
moving said imaging component away from said surface once said particles have stabilized to remain positioned to form said image.

18. The method of claim 7 comprising the additional steps of:
employing an imaging component with a width of said imaging component equal to or greater than one half of a largest diameter of said apertures.
